(19) United States
(12) Patent Application Publication
(10) Pub. No.: US 2013/0277890 A1
(43) Pub. Date: Oct. 24, 2013

(54) Dual-Cure Polymer Systems

(71) Applicants: Christopher Bowman, Boulder, CO (US); Devatha Nair, Lakewood, CO (US); Neil Cramer, Boulder, CO (US); Robin Shandas, Boulder, CO (US)

(72) Inventors: Christopher Bowman, Boulder, CO (US); Devatha Nair, Lakewood, CO (US); Neil Cramer, Boulder, CO (US); Robin Shandas, Boulder, CO (US)

(73) Assignee: The Regents of the University of Colorado, a body corporate, Boulder, CO (US)

(21) Appl. No.: 13/820,601

(22) PCT Filed: Nov. 4, 2011
(86) PCT No.: PCT/US11/59320

§ 371 Date: Jul. 8, 2013

Related U.S. Application Data
(60) Provisional application No. 61/410,192, filed on Nov. 4, 2010.

(51) Int. Cl. C08L 81/02

(52) U.S. Cl. CPC C08L 81/02
USPC 264/496; 525/419; 522/180; 522/174; 522/44; 524/878; 525/426; 525/445

(57) ABSTRACT

The present invention includes compositions that are useful to prepare dual-cure shape memory polymer systems. The present invention further provides methods of generating a shape memory polymer, optical device, polymer pad with an imprint, or suture anchor system.

### STATEMENT REGARDING FEDERALLY SPONSORED RESEARCH OR DEVELOPMENT

This invention was made with government support under grant number BET0626023 awarded by the National Science Foundation and grant numbers HL072738 and HL051506 awarded by the National Institutes of Health. The government has certain rights in the invention.

### BACKGROUND OF THE INVENTION

Polymers and polymeric composites are indispensable materials in the field of manufacturing, combining the advantages of low density, high specific mechanical properties and good corrosion resistance. Nevertheless, universal use of polymeric materials in manufacturing is hampered because polymers cannot be quickly and easily repaired, rather requiring complete and expensive total replacement. Furthermore, the production of intricately shaped parts is still a challenge for the polymer composite industry. Improvements in polymer properties are thus needed to ensure that these materials have more widespread use in the production of both specialty and mass-produced items.

Among the building blocks used in the generation of polymers are thiol-acrylate monomer pairs. Large numbers of thiol and acrylate monomers are available commercially, and these monomers may react via various mechanisms such as Michael addition reactions and free radical polymerizations (Jacobine, “Radiation Curing in Polymer Science and Technology III, Polymerization Mechanisms”; Fouassier & Rabek, Eds.; Elsevier Applied Science: London, 1993; Vol. 3, p. 219; Carioscia et al., 2007, J. Poly. Sci. Part A: Poly Chem. 45:5686-96; Cramer & Bowman, 2001, J. Poly. Sci. 39:3311-19; Hoyle & Bowman, 2007, J. Poly. Sci. Part A: Poly. Chem. 45:5103-11; Lu et al., 2005, Dental Mat. 21:1129-36; Morgan et al., 1977, J. Poly. Sci. Part A: Poly Chem. 15:627-45; Hoyle et al., 2004, J. Poly. Sci. Part A: Poly. Chem. 42:5301-38; Senyurt et al., 2007, Macromol. 40:3174-82; Hoyle et al., 2010, Chem. Soc. Rev. DOI:10.1039/B901979K; Chan et al., 2009, Instrum. 50:3158-68; Chan et al., 2009, Comm. 11:5751-53). Michael reactions are insensitive to oxygen or water, and proceed under relatively mild and solvent-free reaction conditions. A Michael addition crosslinking reaction between a thiol and an acrylate occurs under conditions where other polymerization reactions would not be able to proceed (Chan et al., 2009, Eur. Poly. J. 45(9):2717-25; Rydholm et al., 2005, Biomat. 26(22):4495-4506; Salinas et al., 2008, Macromol. 41(16):6019-26; Kloxin et al., 2010, Adv. Mat. 22(1):61-66; Mather et al., 2006, Progr. Poly. Sci. 31(5):487-531). In the studies performed to date, the stoichiometry of thiol-acrylate Michael addition networks has been kept at 1:1 to ensure formation of fully cross-linked polymeric networks. Additionally, Michael addition reactions have high conversions and cure rates at room temperature, making the corresponding polymer systems an ideal choice for applications such as cellular scaffolds, cross-linked hydrogels, industrial coatings and drug delivery (Rydholm et al., 2005, Biomat. 26(22):4495-4506; Salinas & Anseth, 2008, Macromol. 41(16):6019-26; Kloxin et al., 2010, Adv. Mat. 22(1):61-66; Mather et al., 2006, Progr. Poly. Sci. 31(5):487-531; Mather et al., 2006, Progr. Poly. Sci. 31(5):487-531; Elbert et al., 2006, J. Contr. Rel. 76(1-2):11-25; Pavlinec & Moszner, 1996, J. Appl. Poly. Sci. 65(1):165-78). Other polymers known in the material science area are polyurethanes, formed by the reaction of isocyanates and alcohols, and polythiourethanes, formed by the reaction of isocyanates and thiols.

Shape memory polymers (SMPs) are polymeric smart materials that have the ability to return from a deformed state (temporary shape) to their original (permanent or “memorized”) shape by application of an external stimulus (trigger), such as temperature or light change (“Shape Memory Materials,” Otsuka & Wayman, Eds.; Cambridge University Press: Cambridge, UK, 1998; Duerig et al., 1999, Mat. Sci. & Eng. 273:149-60; Liu et al., 2007, J. Mat. Chem. 17:1543-58; Mather et al., 2009, Ann. Rev. Mat. Res. 39:445-71; Meng & Hu, 2008, Composites A 39:314-21; Meng & Hu, 2009, Composites A 40:1661-72; Xu et al., 2006, Polymer 47:457-65). SMPs were first developed about two decades ago and have been the subject of extensive commercial development in the last decade. Preformed SMPs may be deformed to any desired shape below or above its glass transition temperature (T_{g}). Deformations performed below T_{g} are called “cold deformations”. Deformations performed above T_{g} are called “warm deformations.” In either case, to “lock” in the desired deformed shape, the SMP must remain below, or be quenched at temperatures below, the T_{g}. Once the deformation is locked in, the polymer network cannot return to a relaxed state due to thermal barriers. The SMP holds its deformed shape indefinitely until it is heated above its T_{g}, whereat the stored mechanical strain is released and the SMP returns to its preformed state.

SMPs are simply elastomers or plastics, exhibiting characteristics of both materials, depending on the temperature. While rigid, an SMP demonstrates the strength-to-weight ratio of a rigid polymer. However, normal rigid polymers when heated simply flow or melt into a random new shape, and have no “memorized” shape to which they may return. While heated and pliable, an SMP has the flexibility of a high-quality, dynamic elastomer, tolerating up to 400% elongation or more. However, unlike normal elastomers, an SMP may be reshaped or returned quickly to its memorized shape and subsequently cooled into a rigid plastic.

Several known polymer types exhibit shape memory properties, such as polyurethane polymers (Gordon, 1994, Proc. First Intl. Conf. Shape Memory & Superel. Tech. 115-20; Tobushi et al., 1994, Proc. First Intl. Conf. Shape Memory & Superel. Tech. 109-14). Reported examples of shape memory polymer systems comprising cross-linked unsaturated monomers include polyethylene homopolymers (Ota, 1981, Radiat. Phys. Chem. 18:81), styrene-butadiene thermoplastic copolymers (Japanese Patent Application No. JP 63-179955), polyisoprenes (Japanese Patent Application No. JP 62-192440), copolymers of stearyl acrylate and acrylic acid or methyl acrylate (Kagami et al., 1996, Macromol. Rapid Comm., 17:539-43), norbornene or dimethaneoctahydronapthalene homopolymers or copolymers (U.S. Pat. No. 4,831,094), and styrene copolymers (U.S. Pat. No. 6,759,481).

The shape changing abilities of a SMP may be exploited for minimally invasive biomedical applications in biomedical devices such as stents and endovascular coils. However, a consistently cited drawback of SMPs, especially for biomedical applications, is their lack of mechanical strength and modulus (Liu et al., 2007, J. Mat. Chem. 17:1543-58; Mather et al., 2009, Ann. Rev. Mat. Res. 39:445-71; Meng & Hu, 2008, Comp. A 39:314-21; Meng & Hu, 2009, Comp. A 40:1661-72; Xu et al., 2006, Polymer 47:457-65; Zhang et al., 2008, Polymer 49:3205-10; Rousseau, 2008, Poly. Eng. Sci. 48:2075-89; Xie & Rousseau, 2009, Polymers 50:1852-56; Diani, 2006, Intl. J. Plast. 22:279; Yakacki et al., 2008, Adv. Funct. Mat. 2428-35; Yakacki et al., 2007, Biomat. 28:2255-63; Gall et al., 2002, Microscope 50:5115-26; Ratna & Karger-Kocsis, 2008, J. Mat. Sci. 8:254-69).

Fundamental to the transition that leads to the change in shape of the SMP is a characteristic drop in the modulus of the material. The modulus of a SMP in its rubbery state is several orders of magnitude less than the modulus in the glassy state. In contrast, the mechanical strength of a shape memory NiTinol medical device may vary from 700-2000 MPa (Otsuka & Wayman, Eds., 1998, Cambridge University Press, Cambridge, UK; Liu et al., 2007, J. Mat. Chem. 17:1543-58). SMPs designed to have a high modulus in their rubbery regime often attain it at a cost of reduced strain capacities and compromised shape memory properties (Liu et al., 2007, J. Mat. Chem. 17:1543-58; Rousseau, 2008, Poly. Eng. Sci. 48:2075-89; Xie & Rousseau, 2009, Polymers 50:1852-56; Diani, 2006, Intl. J. Plast. 22:279). This characteristic limits the use of SMPs in potential biomedical applications in which the device has to be strained into its temporary geometry. Past attempts to increase the modulus of the SMP have included synthesizing formulations with increased cross-link density (Yakacki et al., 2008, Adv. Funct. Mat. 2428-35; Yakacki et al., 2007, Biomat. 28:2255-63) and using fillers such as carbon nanotubes (CNT) and MN (Aluminum Nitride) (Gall et al., 2002, Microscope 50:5115-26; Razzaq & Frormann, 2007, Poly. Comp. 28:287-93). Increase in cross-link density reduces the initial strains to which the polymer system may be subjected, thereby limiting the storage or temporary geometry and shape of the device. Use of multiwall carbon nanotubes (MWNTs) as fillers leads to increased polymer processing complexity, undesirable changes in physical properties of the fibers, and degradation of their shape memory properties (Xu et al., 2006, Polymer 47:457-65). Furthermore, the attained increased modulus is still dramatically less than the modulus of a NiTinol shape memory material.

As illustrated in Table 1, an increase in modulus from 3.85 to 16.34 MPa was observed when a urethane shape memory polymer was generated with hydrolysable Si-OEt groups as a cross-linker. By increasing the cross-linker amount from 10% to 40% in a tertiary-butyl acrylate/poly(ethylene glycol)dimethacrylate system, an increase in the rubbery moduli from 1.2 to 8.5 MPa was observed along with decreasing strain-to-failure.

TABLE 1
Typical moduli in the rubbery region of SMP and SMP composites

| Shape Memory Polymer Systems for Biomedical | Rubbery Modulus |
|---|---|
| Applications | (MPa) |
| Shape Memory Urethane Polymer: | 16.34 |
| Xu et al., 2006, Polymer 47: 457-65 | |
| tBA-PEGDMA system: | 8.6 |
| Yakacki et al., 2008, Adv. Funct. Mat. 2428-35; | |
| Yakacki et al., 2007, Biomat. 28: 2255-63 | |
| SMP epoxy system, DP7AR with SiC nano particles: | 15.6 |
| Gall et al., 2002, Microscope 50: 5115-26 | |

There is an ever-present need to economically manufacture small-scale devices, such as lithographic impression devices, where a pattern is imprinted with micron and nano-scale resolution. A challenge in the area of nano- and micro-patterning is finding an appropriate photopolymerizable material with low viscosity, low shrinkage and ability to form stable polymer networks that enable mold removal without loss of detail. Although soft and highly flexible molds, such as those made from polydimethylsiloxane (PDMS), enable imprinting at reduced pressures, the elastomeric behavior of the polymer may result in a non-uniform negative being formed from the master pattern. Also, as PDMS swells in most organic solvents used to lower its viscosity, this results in further distortion of the master pattern.

Optical devices with patterned refractive index variations in thick (>>1 mm) solids are difficult to prepare via traditional photoresist methodologies (Syms, In “Practical Volume Holography” (Oxford University Press, Oxford, 1990); Krongauz & Trifunac, In “Processes In Photoreactive Photopolymers” (Chapman & Hall, New York, 1994); Chang & Leonard, 1979, Appl. Opt. 48:2407). Silver halide photographic emulsions can record holograms with sub-200 nm resolution, but these systems require solvent-based processing, undergo swelling during wet processing, and afford film thicknesses limited to approximately 10 μm (Close et al., 1969, Appl. Phys. Lett. 14:159-160). Dichromated gelatin (DCG) is an important holographic material and can achieve index contrasts of approximately 0.1 or greater. However, in addition to requiring complex wet processing, DCG holograms are extremely sensitive to moisture and must be protected from ambient humidity to remain stable. Self-developing photopolymers can achieve index variations of approximately 0.01 in films of several millimeters without necessitating any solvent-based processing (Colburn & Haines, 1971, Appl. Opt. 10:1636). Structured illumination initiates polymerization, locally depleting monomer and reducing free-volume. After mass transport is completed, a uniform optical flood cure consumes the remaining photo-initiator and monomer, leaving an index-patterned, photo-insensitive structure that is stable to most environmental conditions. This process must take place within a solid matrix, which provides a physical scaffold for the photopolymer structure, allows rapid diffusion of low molecular-weight species, and has the required passive mechanical and optical properties. However, this system has a fundamental problem: the matrix must be above its glass-transition temperature for efficient diffusion and remain so during operation. This rubbery matrix requires a sealed solid enclosure to render it rigid and suppress in-diffusion of environmental contaminants. Many applications are not compatible with this rubbery, high-diffusion state and instead require a final polymer that is mechanically and chemically robust.

There is thus a need in the art to develop novel SMPs, which may be employed more widely in biomedical applications. Such SMPs should be easily assembled from commercially available monomers, have better mechanical properties and moduli in the rubbery regime than currently available SMPs, and also have favorable shape memory characteristics. The present invention fulfills this need.

### BRIEF SUMMARY OF THE INVENTION

The invention includes a method of generating a given polymer. The method comprises the step of providing an initial composition comprising a first polymerizable composition and a second polymerizable composition. The first polymerizable composition undergoes polymerization when submitted to a first polymerization reaction condition, and the second polymerizable composition undergoes polymerization when submitted to a second polymerization reaction condition. Further, the first and second polymerization reaction conditions are orthogonal to each other. The method further comprises the step of submitting the initial composition to the first polymerization reaction condition to promote polymerization of the first polymerizable composition, thereby forming an intermediate composition. The method further comprises the step of submitting the intermediate composition to the second polymerization reaction condition to promote polymerization of the second polymerizable composition, thereby forming the given polymer.

In one embodiment, the given polymer is used to prepare at least one material selected from the group consisting of a shape memory polymer, optical material, impression material, and combinations thereof.

In one embodiment, the initial composition comprises a polymerization photoinitiator, at least one acrylate monomer, and a component selected from the group consisting of: (a) at least one thiol monomer, wherein the ratio of the thiol equivalent concentration of the at least one thiol monomer in the initial composition and the acrylate equivalent concentration of the at least one acrylate monomer in the initial composition ranges from about 0.05 to about 0.95; and (b) a mixture of at least one nucleophile monomer and at least one isocyanate monomer, wherein the ratio of the nucleophile equivalent concentration of the at least one nucleophilic monomer in the initial composition and the isocyanate equivalent concentration of the at least one isocyanate monomer in the initial composition is about 1:1; and, wherein the at least one nucleophile monomer comprises a thiol monomer or alcohol monomer. In another embodiment, the initial composition is shaped into a given shape. In yet another embodiment, the first polymerization reaction condition promotes a reaction selected from the group consisting of: (a) a reaction between the at least one acrylate monomer and the at least one thiol monomer, and (b) a reaction between the at least one nucleophile monomer and the at least one isocyanate monomer. In yet another embodiment, the intermediate composition comprises unreacted acrylate monomer. In yet another embodiment, the second polymerization reaction condition promotes photopolymerization of the unreacted acrylate monomer. In yet another embodiment, the given polymer has enhanced mechanical properties over the intermediate composition. In yet another embodiment, the initial composition further comprises a compound selected from the group consisting of an accelerator, urethane based acrylate, and combinations thereof. In yet another embodiment, the at least one thiol monomer is selected from the group consisting of 2,5-dimercaptomethyl-1,4-dithiane, 2,3-dimercapto-1-propanol, 2-mercapto-ethylsulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, isophorone diurethane thiol, and combinations thereof.

In one embodiment, the at least one acrylate monomer is selected from the group consisting of ethylene glycoldi(meth)acrylate, tetraethyleneglycol-di(meth)acrylate, poly(ethylene glycol)dimethacrylates, the condensation product of bisphenol A and glycidyl methacrylate, 2,2′-bis[4-(3-methacryloxy-2-hydroxypropoxy)-phenyl]propane, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl(meth)acrylate trimethylolpropane triacrylate, tricyclodecane dimethanol diacrylate, and combinations thereof.

In one embodiment, the polymerization photoinitiator is selected from the group consisting of 2,2-dimethoxy-1,2-diphenylethan-1-one, bis(2,4,6-trimethylbenzoyl)-phenylphosphineoxide, 1-hydroxycyclohexyl benzophenone, trimethyl-benzoyl-diphenyl-phosphine-oxide, and combinations thereof; and the photopolymerization is promoted by UV radiation.

In one aspect, the given polymer is used to prepare an optical device. In one embodiment, the initial composition comprises a polymerization photoinitiator, at least one acrylate monomer, and a component selected from the group consisting of: (a) at least one thiol monomer, wherein the ratio of the thiol equivalent concentration of the at least one thiol monomer in the initial composition and the acrylate equivalent concentration of the at least one acrylate monomer in the initial composition ranges from about 0.05 to about 0.95; and (b) a mixture of at least one nucleophile monomer and at least one isocyanate monomer, wherein the ratio of the nucleophile equivalent concentration of the at least one nucleophilic monomer in the initial composition and the isocyanate equivalent concentration of the at least one isocyanate monomer in the initial composition is about 1:1; and wherein the at least one nucleophile monomer comprises a thiol monomer or alcohol monomer. In another embodiment, the initial composition is shaped into a given shape. In yet another embodiment, the first polymerization reaction condition promotes a reaction selected from the group consisting of: (a) a reaction between the at least one acrylate monomer and the at least one thiol monomer, and (b) a reaction between the at least one nucleophile monomer and the at least one isocyanate monomer. In yet another embodiment, the intermediate composition comprises unreacted acrylate monomer. In yet another embodiment, refractive index gradients are written into the intermediate composition. In yet another embodiment, the second polymerization reaction condition promotes photopolymerization of the unreacted acrylate monomer, thereby forming the optical device.

In one embodiment, the initial composition further comprises an accelerator, urethane based acrylate, or a combination thereof. In another embodiment, the initial composition further comprises at least one high-refractive index acrylate. In yet another embodiment, the at least one high-refractive index acrylate comprises 2,4,6-tribromophenyl acrylate.

In one aspect, the given polymer is used to prepare a polymer pad with a given imprint. In one embodiment, the initial composition comprises a polymerization photoinitiator, at least one acrylate monomer, and a component selected from the group consisting of: (a) at least one thiol monomer, wherein the ratio of the thiol equivalent concentration of the at least one thiol monomer in the initial composition and the acrylate equivalent concentration of the at least one acrylate monomer in the initial composition ranges from about 0.05 to about 0.95; and (b) a mixture of at least one nucleophile monomer and at least one isocyanate monomer, wherein the ratio of the nucleophile equivalent concentration of the at least one nucleophilic monomer in the initial composition and the isocyanate equivalent concentration of the at least one isocyanate monomer in the initial composition is about 1:1; and, wherein the at least one nucleophile monomer comprises a thiol monomer or alcohol monomer. In another embodiment, the initial composition is shaped into a given shape. In yet another embodiment, the first polymerization reaction condition promotes a reaction selected from the group consisting of: (a) a reaction between the at least one acrylate monomer and the at least one thiol monomer, and (b) a reaction between the at least one nucleophile monomer and the at least one isocyanate monomer. In yet another embodiment, the intermediate composition comprises unreacted acrylate monomer. In yet another embodiment, the intermediate composition is pressed into a master pattern block, wherein the block comprises the negative image of the given imprint. In yet another embodiment, the second polymerization reaction condition promotes photopolymerization of the unreacted acrylate monomer, thereby forming the given imprint on the polymer pad.

In one embodiment, the initial composition further comprises an accelerator. In another embodiment, the initial composition further comprises a polymerization photoinitiator.

The invention also includes a composition comprising at least one component selected from the group consisting of: (a) an acrylate monomer and at least one thiol monomer, wherein the ratio of the thiol equivalent concentration of the at least one thiol monomer in the composition and the acrylate equivalent concentration of the at least one acrylate monomer in the composition ranges from about 0.05 to about 0.95; (b) a mixture of at least one nucleophile monomer and at least one electrophile monomer, wherein the ratio of the nucleophile equivalent concentration of the at least one nucleophile monomer in the composition and the electrophile equivalent concentration of the at least one electrophile monomer in the composition ranges from about 2:1 to about 1:2; wherein the at least one electrophile monomer comprises an isocyanate monomer or epoxy monomer; and, wherein the at least one nucleophile monomer comprises a thiol monomer or alcohol monomer; (c) at least one thiol monomer and at least one monomer selected from the group consisting of acrylate, methacrylate, acrylamide, methacrylamide, maleimide, acrylonitrile, cyanoacrylate and combinations thereof, further optionally comprising a phosphine; and (d) at least one thiol monomer, at least one acrylate monomer, and at least one ene monomer, wherein the ratio of the at least one thiol monomer to the at least one acrylate monomer is greater than about 1:1.

In one embodiment, the at least one thiol monomer is selected from the group consisting of 2,5-dimercaptomethyl-1,4-dithiane, 2,3-dimercapto-1-propanol, 2-mercapto-ethylsulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, isophorone diurethane thiol, and combinations thereof.

In one embodiment, the at least one acrylate monomer is selected from the group consisting of ethylene glycol di(meth)acrylate, tetraethyleneglycol-di(meth)acrylate, poly(ethylene glycol)dimethacrylates, the condensation product of bisphenol A and glycidyl methacrylate, 2,2′-bis[4-(3-methacryloxy-2-hydroxypropoxy)-phenyl]propane, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl(meth)acrylate trimethylolpropane triacrylate, tricyclodecane dimethanol diacrylate, and combinations thereof.

In one embodiment, the composition further comprises an accelerator. In another embodiment, the composition further comprises a polymerization photoinitiator. In yet another embodiment, the polymerization photoinitiator is selected from the group consisting of 2,2-dimethoxy-1,2-diphenylethan-1-one, bis(2,4,6-trimethylbenzoyl)-phenylphosphineoxide, 1-hydroxycyclohexyl benzophenone, trimethyl-benzoyl-diphenyl-phosphine-oxide, and combinations thereof.

In one embodiment, the composition further comprises a filler. In another embodiment, the filler comprises at least one selected from the group consisting of a silica particle, Kevlar veil, PET mesh, fiber mesh, metal mesh, Multi-Walled Carbon NanoTube (MWCNTs), Carbon NanoTube (CNTs), organoclay, clay, alumina, titania, zirconia, carbon, bioglass, hydroxyapatite (HA) particle/mesh, quartz, barium glass, barium salt, titanium dioxide, and combinations thereof.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 illustrates the chemical structures of monomers used in this application.

FIG. 2, comprising FIGS. 2A-2E, illustrates the shape memory programming and recovery of the Eb8402-TCDDA-PETMP system. FIG. 2A illustrates the permanent shape of the polymer before programming FIG. 2B illustrates the temporary stored shape of the polymer at a temperature T<T_{g} (T_{g} is the glass transition temperature). On exposing the system to a temperature T>T_{g}, the polymer recovered its original shape (FIGS. 2C-2E).

FIG. 3 is a graph illustrating the first and second cure glass transition temperatures resulting from different acrylate to thiol ratios of TMPTA and PETMP.

FIG. 4, comprising FIGS. 4A-4B, is a series of graphs illustrating the tan delta and moduli vs. temperature profile for a system comprising TMPTA-PETMP, wherein the acrylate to thiol ratio is 2:1, before (FIG. 4A) and after (FIG. 4B) the second stage of the cure process.

FIG. 5, comprising FIG. 5A-5B, is a series of graphs illustrating the tan delta and modulus vs. temperature profile for a system comprising Eb1290-TMPTA-PETMP, wherein the acrylate to thiol ratio is 1.5:1, before (FIG. 5A) and after (FIG. 5B) the second stage of the cure process.

FIG. 6 is a bar graph illustrating the different glass transition temperatures obtained from DMA results at the end of first stage (or stage 1) and second stage (or stage 2) cures for different stoichiometric ratios of thiol-to-acrylate.

FIG. 7, comprising FIGS. 7A-7C, is a set of rheology graphs illustrating the evolution of Modulus between the first and second stages of curing. Two different stoichiometric ratios of thiol to acrylate (1:1.5 and 1:2) are compared for PETMP-TCDDA (FIGS. 7A-7B), and for PETMP-TMPTA (FIG. 7C).

FIG. 8 is a series of differential interference contrast (DIC) images of the lithography pattern obtained from the two-stage polymer gel.

FIG. 9, comprising FIGS. 9A-9D, illustrates a shape memory polymer coil being deployed from a 4-French catheter. The coils are shown in stage 1. Once the coils are deployed in their final shape, the second reaction (stage 2) may be initiated, thus increasing the modulus of the polymer.

FIG. 10, comprising FIGS. 10A-10B, illustrates a polymer system of the invention. FIG. 10A illustrates the high strain, low modulus, loosely cross-linked first-stage system with non-polymerized functional groups present. FIG. 10B illustrates the second-stage system, wherein polymerization results in a highly cross-linked, high-modulus polymer system.

FIG. 11, comprising FIGS. 11A-11C, illustrates the process of microimprinting using a composition of the invention. As illustrated in FIG. 11A, a master pattern block with a micro-imprinted pattern is prepared. As illustrated in FIG. 11B, a polymer pad formed after the First stage reaction is pressed against the pattern block and UV cured. As illustrated in FIG. 11C, at the end of the Stage 2 cure, the negative image of the pattern is imprinted on the polymer pad.

FIG. 12, comprising FIGS. 12A-12B, is a set of graphs illustrating compositions of the invention. The x-axis represents the formulations in Example 8. In FIG. 12A, the y-axis represents the T_{g} values achieved at the end of stage 1 and stage 1 and stage 2 for the dual-cure networks formed from F-230, F-8402, F-220 and F-1290. In FIG. 12B, the y-axis represents the rubbery modulus of the systems, measured at T_{g}+35 for the stage 1 systems and at T_{g}+65 for the stage 2 systems.

FIG. 13 is a graph illustrating the Stage 2 acrylate conversion for (from top to bottom) Eb-230, Eb-840, Eb-1290 and Eb-220. The systems comprised 0.8 wt % TEA and 0.5 wt % Irgacure 651 and were irradiated at 20 mW/cm². At the end of stage 1, 64.3% of the acrylates in the F-230 system were unreacted, whereas the F-8402 and F-220 had 66% of the acrylates unreacted within the network. The F-1290 systems had 50% of unreacted acrylates.

FIG. 14, comprising FIGS. 14A-14C, is a series of graphs illustrating experimental results for compression tests in Example 8. The peak stress that the polymer networks achieved at the end of each stage is illustrated in FIG. 14A. FIG. 14B illustrates reduction in strain as a result of the stage 2 cure. FIG. 14C illustrates the calculated toughness at the end of each stage.

FIG. 15, comprising FIGS. 15A-15B, is a set of SEM images of the S1 composites showing silica particle dispersion at 10 volume % (FIG. 15A) and 20 volume % (FIG. 15B).

FIG. 16, comprising FIGS. 16A-16B, is a set of SEM images of the S2 composites showing silica particle dispersion at 10 volume % (FIG. 16A) and 20 volume % (FIG. 16B).

FIG. 17, comprising FIGS. 17A-17B, is a set of graphs illustrating glass transition temperatures for compositions of the invention. The different composite systems are illustrated on the x-axis in FIGS. 17A and 17B, along with the glass transition temperatures on the y-axis. The stage 1 T_{g} of S1 composites systems showed no significant variation with that of the neat polymer matrix, which has a T_{g} of 30±3° C. (FIG. 17A). The S2 composites also did not significantly alter the T_{g} of the neat polymer matrix at −2±4° C. (FIG. 17B). The peak of the tan delta (δ) curve was designated as the T_{g}.

FIG. 18, comprising FIGS. 18A-18B, is a set of graphs illustrating state 1 rubbery modulus for compositions of the invention. The composite systems for S1 and S2 are detailed on the x axis of FIGS. 18A-18B. FIG. 18A: The stage 1 rubbery modulus of S1 composites systems achieved an increase in modulus as compared to the neat polymer matrix. FIG. 18B: A similar increase in modulus was observed for all S2 composites except the S2 silica particle composite. The neat polymer matrix modulus for S1 and S2 was 20±2 MPa and 6±2 MPa respectively. The rubbery modulus was measured at a temperature of T_{g}+35° C.

FIG. 19, comprising FIGS. 19A-19B, is a set of graphs illustrating T_{g} for compositions of the invention. The composite formulations are illustrated on the x-axis in FIGS. 19A-19B. FIG. 19A: The stage 2 T_{g} of S1 composites systems showed no significant variation from the neat polymer matrix (T_{g} of 82±4° C.). FIG. 19B: The S2 composites did not significantly alter the T_{g} of the neat polymer matrix at 18±5° C. The peak of the tan delta curve was designated as the T_{g}.

FIG. 20, comprising FIGS. 20A-20B, is a set of graphs illustrating stage 2 rubbery modulus for compositions of the invention. Composite formulations are on the x-axis. The rubbery modulus for the S1 composites at stage 2 (FIG. 20A) and the S2 composites at stage 2 (FIG. 20B) were measured at a temperature of T_{g}+65. The neat polymer matrix modulus at stage 2 for S1 and S2 polymers were 77±10 MPa and 14±5 MPa respectively.

FIG. 21 is a graph illustrating the Young's modulus of trabecular bone as a function of density of bone. Bone density varies with age, sex and disease and directly correlates to bone strength.

FIG. 22 is an illustration of the tensile test. (a) A dog-bone shape grip was inserted in the lower cylinder of the tensile test machine. (b) Once the dog-bone was inserted in the cavity, the cover was placed on the grip and help in place. The dog-bone was cured in-situ within the grip at 8 mW/cm².

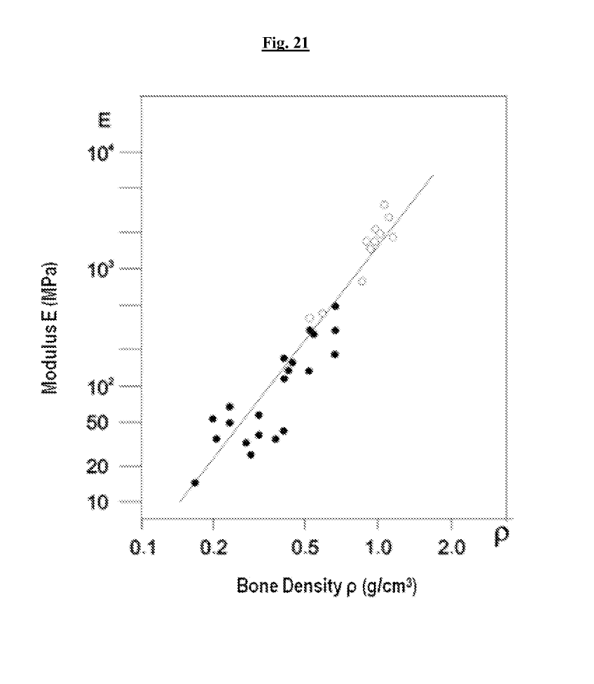

FIG. 23 is an illustration of a hologram image recorded on the dual-cure polymer matrix. The Stage 1 polymer was used as a photoresist to capture the interference pattern that was recorded on it. The diffraction grating was seen as a result of interference, indicating a refractive index gradient which was then imaged on a brightfield microscope.

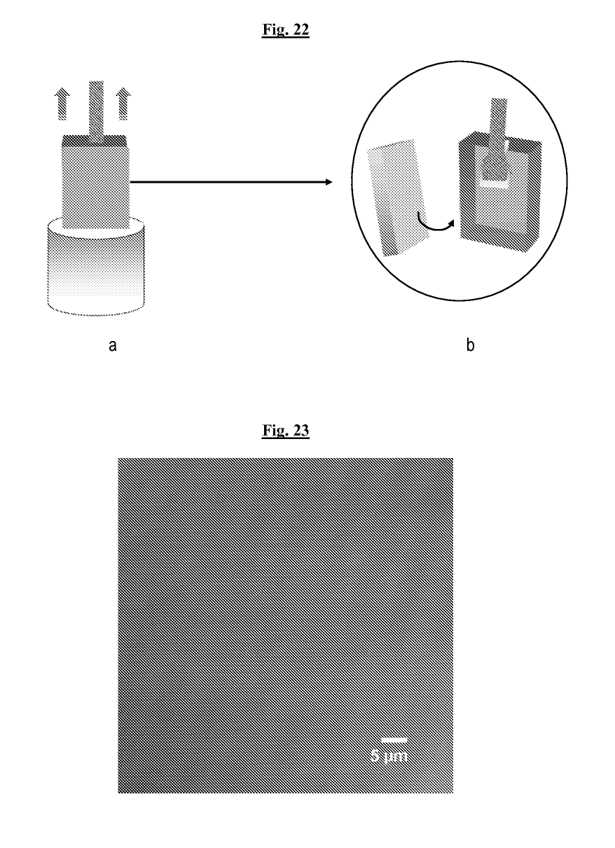

### DETAILED DESCRIPTION OF THE INVENTION

The present invention relates to the discovery of a novel shape memory polymer system. This system may be generated by any combination of reactions capable of generating distinct first-stage and second-stage polymerizations and polymers.

In one aspect, the invention relates to the unexpected discovery of a composition comprising a given polymer may be assembled by a two-stage polymerization process. The invention contemplates an initial composition comprising a first polymerizable composition and a second polymerizable composition. According to the invention, the first polymerizable composition undergoes polymerization when submitted to a first polymerization reaction condition, and the second polymerizable composition undergoes polymerization when submitted to a second polymerization reaction condition. The first and second polymerization reaction conditions are selected so that they are orthogonal to each other. The initial composition is submitted to the first polymerization reaction condition, so that polymerization of the first polymerizable composition is promoted and an intermediate composition is formed. The intermediate composition may be optionally submitted to any procedure, such as reshaping or appropriate physical manipulations. The intermediate composition is then submitted to the second polymerization reaction condition, so that polymerization of the second polymerizable composition is promoted and a given polymer is formed.

In one aspect, this system may be generated by a two-stage cure process of a composition comprising a non-stoichiometric mixture of thiol and acrylate monomers. In the first stage of the cure process, the monomers undergo crosslinking by a Michael addition mechanism to form a stable first stage polymer. In the second stage of the cure process, unreacted acrylate monomers undergo photoinduced polymerization to form a stable second stage polymer.

In another aspect, this system may be generated by a two-stage cure process of a composition comprising an isocyanate and a nucleophile (such as an alcohol or thiol), wherein the composition further comprises a (meth)acrylate, acrylamide, vinyl ether, thiol-ene, or any other photopolymerizable functional group. The first stage of the process comprises the polymerization reaction of the isocyanate with the nucleophile (such as the alcohol or thiol) to form a stable first stage polymer. The second stage of the process comprises photoinduced polymerization of the acrylate monomers to form a stable second stage polymer. In a non-limiting aspect, the system further comprises a filler.

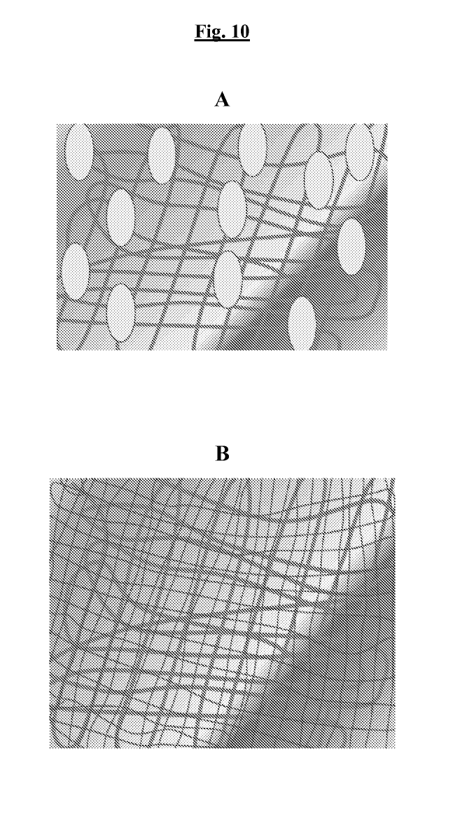

The lower-crosslinked (or intermediate) polymer formed after the first stage of polymerization has the capacity of attaining idealized shape memory responses and storing high strains. In the second stage of the cure process, the still-unreacted functional groups undergo partial or complete crosslinking upon irradiation, generating a final polymer with high modulus and stiffness (FIG. 10).

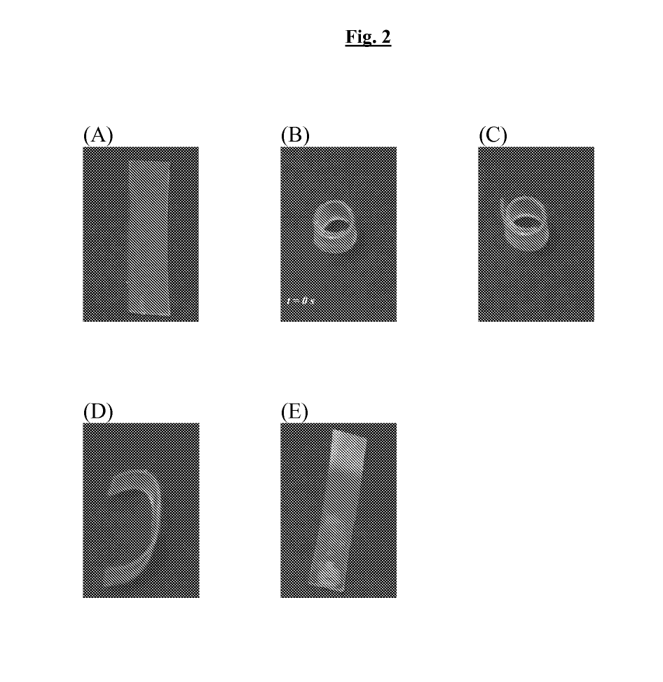

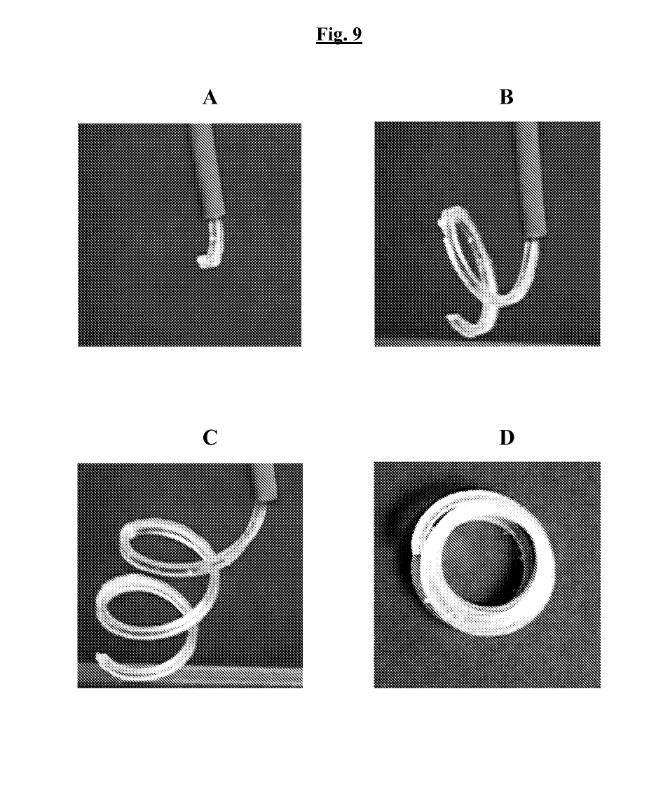

The dual-cure polymer system of the invention has unexpected favorable mechanical properties and moduli in the rubbery regime, along with favorable shape memory characteristics. This system may be engineered as a dual-cure shape memory polymer, dual-cure impression material or dual-cure optical device (wherein refractive index patterns are written). The system is appropriate for biomedical applications (such as orthopedics), wherein its desirable mechanical properties (desirable modulus and stiffness) may be achieved in-situ (non-limiting examples are illustrated in FIGS. 2 and 9).

### DEFINITIONS

As used herein, each of the following terms has the meaning associated with it in this section.

Unless defined otherwise, all technical and scientific terms used herein generally have the same meaning as commonly understood by one of ordinary skill in the art to which this invention belongs. Generally, the nomenclature used herein and the laboratory procedures in material science, solid phase chemistry and organic chemistry are those well-known and commonly employed in the art.

As used herein, the articles “a” and “an” refer to one or to more than one (i.e. to at least one) of the grammatical object of the article. By way of example, “an element” means one element or more than one element.

As used herein, the term “about” will be understood by persons of ordinary skill in the art and will vary to some extent on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “polymer” refers to a molecule composed of repeating structural units typically connected by covalent chemical bonds. The term “polymer” is also meant to include the terms copolymer and oligomers.

As used herein, the term “Michael addition” refers to the nucleophilic addition of a carbanion or another nucleophile to an α,β-unsaturated carbonyl compound to form a β-substituted carbonyl compound.

As used herein, the term “PETMP” refers to pentaerythritol tetra-(3-mercaptopropionate).

As used herein, the term “TMPTA” refers to trimethylolpropane triacrylate.

As used herein, the term “TMPTMP” refers to trimethylol propane tris-(3-mercaptopropionate).

As used herein, the term “DMPA” refers to 2,2-dimethoxy-2-phenyl-acetophenone.

As used herein, the term “IPDUTh” refers to isophorone diurethane thiol.

As used herein, the term “TCDDA” refers to tricyclodecane dimethanol diacrylate.

As used herein, the term “TEA” refers to triethylamine.

As used herein, the term “reaction condition” refers to a physical treatment, chemical reagent, or combination thereof, which is required or optionally required to promote a reaction. Non-limiting examples of reaction conditions are electromagnetic radiation, heat, a catalyst, a chemical reagent (such as, but not limited to, an acid, base, electrophile or nucleophile), and a buffer.

As used herein, the term “electromagnetic radiation” includes radiation of one or more frequencies encompassed within the electromagnetic spectrum. Non-limiting examples of electromagnetic radiation comprise gamma radiation, X-ray radiation, UV radiation, visible radiation, infrared radiation, microwave radiation, radio waves, and electron beam (e-beam) radiation. In one aspect, electromagnetic radiation comprises ultraviolet radiation (wavelength from about 10 nm to about 400 nm), visible radiation (wavelength from about 400 nm to about 750 nm) or infrared radiation (radiation wavelength from about 750 nm to about 300,000 nm). Ultraviolet or UV light as described herein includes UVA light, which generally has wavelengths between about 320 and about 400 nm, UVB light, which generally has wavelengths between about 290 nm and about 320 nm, and UVC light, which generally has wavelengths between about 200 nm and about 290 nm. UV light may include UVA, UVB, or UVC light alone or in combination with other type of UV light. In one embodiment, the UV light source emits light between about 350 nm and about 400 nm. In some embodiments, the UV light source emits light between about 400 nm and about 500 nm.

As used herein, the term “reactive” as applied to thiol, alcohol, isocyanate, acrylate or ene groups indicate that these groups, when submitted to appropriate conditions, may take part in the reaction in question.

As used herein, the term “polymerization” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combination thereof. A polymerization reaction may consume between about 0% and about 100% of the at least one functional group available in the system. In one embodiment, polymerization of at least one functional group results in about 100% consumption of the at least one functional group. In another embodiment, polymerization of at least one functional group results in less than about 100% consumption of the at least one functional group.

As used herein, the term “thiol monomer” corresponds to a compound having a discrete chemical formula and comprising at least a sulfhydryl or thiol group (—SH), or a reactive oligomer or reactive polymer or pre-polymer having at least one thiol group.

As used herein, the term “thiol equivalent concentration” for a thiol monomer in a sample corresponds to the concentration of reactive thiol groups in the sample related to the thiol monomer. In a non-limiting example, the thiol equivalent concentration of a thiol monomer in a solution corresponds to the product of the average number of reactive thiol groups in a thiol monomer and the average concentration of the thiol monomer in the solution.

As used herein, the term “nucleophile equivalent concentration” for a nucleophile monomer in a sample corresponds to the concentration of reactive nucleophilic groups in the sample related to the nucleophile monomer. In a non-limiting example, the nucleophile equivalent concentration of a nucleophile monomer in a solution corresponds to the product of the average number of reactive nucleophile groups in a nucleophile monomer and the average concentration of the nucleophile monomer in the solution. In one embodiment, the nucleophile group is an alcohol hydroxyl, phenol hydroxyl or thiol.

As used herein, the term “acrylate monomer” corresponds to a compound having a discrete chemical formula and comprising at least one acrylate group (exemplified as —C(R¹)═C(R²)—C(═O)—), wherein R¹ and R² are independently hydrogen or alkyl), or a reactive oligomer or reactive polymer or pre-polymer having at least one acrylate group In a non-limiting embodiment, the term “acrylate” encompass a methacrylate, wherein R² is methyl.

As used herein, the term “acrylate equivalent concentration” for an acrylate monomer in a sample corresponds to the concentration of reactive acrylate groups in the sample related to the acrylate monomer. In a non-limiting example, the acrylate equivalent concentration of an acrylate monomer in a solution corresponds to the product of the average number of reactive acrylate groups in an acrylate monomer and the average concentration of the acrylate monomer in the solution.

As used herein, the term “orthogonal,” as applied to the conditions required to run at least two distinct chemical reactions, indicates that the conditions used to perform one of the chemical reactions do not significantly affect the ability to perform the subsequent other(s) chemical reaction(s). In a non-limiting example, reactions R1 and R2 may be performed in a system, wherein R1 is run first and R2 is run second; reactions R1 and R2 are performed under “orthogonal” conditions if reaction R1 may be performed in the system under conditions that do not affect the ability to subsequently perform reaction R2 in the system.

As used herein, the term “elasticity” is defined as the ability of a material to return to its original shape and size after being stretched. A material is considered to be elastic if it deforms under stress (e.g., external forces), but returns to its original shape when the stress is removed.

As used herein, the term “instructional material” includes a publication, a recording, a diagram, or any other medium of expression that may be used to communicate the usefulness of the compositions of the invention. In some instances, the instructional material may be part of a kit useful for generating a shape memory polymer system. The instructional material of the kit may, for example, be affixed to a container that contains the compositions of the invention or be shipped together with a container that contains the compositions. Alternatively, the instructional material may be shipped separately from the container with the intention that the recipient uses the instructional material and the compositions cooperatively. For example, the instructional material is for use of a kit; instructions for use of the compositions; or instructions for use of a formulation of the compositions.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Compositions of the Invention

The present invention contemplates a dual-cure system that exhibits a first polymerization reaction (or a first stage of the cure procedure) to form an intermediate polymer network and a second polymerization reaction (or a second stage of the cure procedure) to form the final polymer network. In one aspect, this network is a useful and novel shape memory polymer system.

The novel dual-cure shape memory polymer system has a first set of distinct mechanical properties that enables optimum deployment of a device, and a second set of properties that can be achieved in situ, once the deployed device is in place. To achieve these two distinct stages within the device, an initial polymerization reaction forms a shape memory polymer network with properties such as the glass transition temperature T_{g1}. Once the shape memory device has been deployed and is in place, in a second reaction (triggered by photoirradiation, for example), at least a fraction of the remaining functional groups are photopolymerized. In one embodiment, about all the remaining functional groups are photopolymerized. In another embodiment, a given fraction of the remaining functional groups is photopolymerized. The ensuing polymer exhibits a second set of material properties comprising the glass transition temperature T_{g2}, where T_{g2}>T_{g1} and consequently a polymer with a higher modulus is obtained. The two reaction conditions are orthogonal to each other.

The invention includes a composition comprising at least one component selected from the group consisting of: (a) an acrylate monomer and at least one thiol monomer, wherein the ratio of the thiol equivalent concentration of the at least one thiol monomer in the composition and the acrylate equivalent concentration of the at least one acrylate monomer in the composition ranges from about 0.05 to about 0.95; (b) a mixture of at least one nucleophile monomer and at least one electrophile monomer, wherein the ratio of the nucleophile equivalent concentration of the at least one nucleophile monomer in the composition and the electrophile equivalent concentration of the at least one electrophile monomer in the composition ranges from about 2:1 to about 1:2; wherein the at least one electrophile monomer comprises an isocyanate monomer or epoxy monomer; and wherein the at least one nucleophile monomer comprises a thiol monomer or alcohol monomer; (c) at least one thiol monomer and at least one monomer selected from the group consisting of acrylate, methacrylate, acrylamide, methacrylamide, maleimide, acrylonitrile, cyanoacrylate and combinations thereof, further optionally comprising a phosphine; and, (d) at least one thiol monomer, at least one acrylate monomer, and at least one ene monomer, wherein the ratio of the at least one thiol monomer to the at least one acrylate monomer is greater than about 1:1. In one embodiment, the phosphine is present between 1 ppm and 100,000 ppm in the composition.

The invention includes a composition comprising at least one thiol monomer and at least one acrylate monomer. In one embodiment, the amounts of the at least one thiol monomer and the at least one acrylate monomer in the composition of the invention are selected so that the thiol equivalent concentration is sub-stoichiometric with respect to the acrylate equivalent concentration.

In one embodiment, the ratio of the thiol equivalent concentration to the acrylate equivalent concentration in the composition ranges from about 0.05 to about 0.95. In another embodiment, the ratio of the thiol equivalent concentration to the acrylate equivalent concentration in the composition ranges from about 0.1 to about 0.95. In yet another embodiment, the ratio of the thiol equivalent concentration to the acrylate equivalent concentration in the composition ranges from about 0.2 to about 0.95. In yet another embodiment, the ratio of the thiol equivalent concentration to the acrylate equivalent concentration in the composition ranges from about 0.3 to about 0.95. In yet another embodiment, the ratio of the thiol equivalent concentration to the acrylate equivalent concentration in the composition ranges from about 0.4 to about 0.95. In yet another embodiment, the ratio of the thiol equivalent concentration to the acrylate equivalent concentration in the composition ranges from about 0.5 to about 0.95. In yet another embodiment, the ratio of the thiol equivalent concentration to the acrylate equivalent concentration in the composition ranges from about 0.5 to about 0.9. In yet another embodiment, the ratio of the thiol equivalent concentration to the acrylate equivalent concentration in the composition ranges from about 0.5 to about 0.8. In yet another embodiment, the ratio of the thiol equivalent concentration to the acrylate equivalent concentration in the composition ranges from about 0.5 to about 0.7. In yet another embodiment, the ratio of the thiol equivalent concentration to the acrylate equivalent concentration in the composition ranges from about 0.5 to about 0.67. In yet another embodiment, the ratio of the thiol equivalent concentration to the acrylate equivalent concentration in the composition ranges from about 0.3 to about 0.95.

In one embodiment, the ratio of the thiol equivalent concentration to the acrylate equivalent concentration in the composition is about 0.1. In another embodiment, the ratio of the thiol equivalent concentration to the acrylate equivalent concentration in the composition is about 0.2. In yet another embodiment, the ratio of the thiol equivalent concentration to the acrylate equivalent concentration in the composition is about 0.3. In yet another embodiment, the ratio of the thiol equivalent concentration to the acrylate equivalent concentration in the composition is about 0.33. In yet another embodiment, the ratio of the thiol equivalent concentration to the acrylate equivalent concentration in the composition is about 0.4. In yet another embodiment, the ratio of the thiol equivalent concentration to the acrylate equivalent concentration in the composition is about 0.5. In yet another embodiment, the ratio of the thiol equivalent concentration to the acrylate equivalent concentration in the composition is about 0.6. In yet another embodiment, the ratio of the thiol equivalent concentration to the acrylate equivalent concentration in the composition is about 0.7. In yet another embodiment, the ratio of the thiol equivalent concentration to the acrylate equivalent concentration in the composition is about 0.8. In yet another embodiment, the ratio of the thiol equivalent concentration to the acrylate equivalent concentration in the composition is about 0.9. In yet another embodiment, the ratio of the thiol equivalent concentration to the acrylate equivalent concentration in the composition is about 0.95.

Thiol monomers contemplated within the invention may have two or more thiol groups per molecule of thiol monomer. Non-limiting examples of thiol monomers contemplated within the invention include, e.g., polymercaptoacetate and/or polymercaptopropionate esters, in particular the pentaerythritol tetra esters and/or trimethylolpropane triesters. Additional non-limiting examples of thiol monomers include 2,5-dimercaptomethyl-1,4-dithiane, 2,3-dimercapto-1-propanol, 2-mercapto-ethylsulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, isophorone diurethane thiol, and the like. In one embodiment, the thiol monomers contemplated within the invention may be combined with one or more thiols that have a single sulfhydryl group, such as thioglycolic acid (also known as 2-mercapto-acetic acid), α-mercapto-propionic acid or β-mercapto-propionic acid.

Acrylate monomers contemplated within the invention may have one or more acrylate groups per molecule of acrylate monomer. Non-limiting examples of acrylate monomers include ethylene glycol-di(meth)acrylate, tetraethyleneglycol-di(meth)acrylate (TEGDMA), poly(ethylene glycol)dimethacrylates, the condensation product of bisphenol A and glycidyl methacrylate, 2,2′-bis[4-(3-methacryloxy-2-hydroxypropoxy)-phenyl]propane (bis-GMA), hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl(meth)acrylate trimethylolpropane triacrylate and tricyclodecane dimethanol diacrylate.

In one embodiment, the composition further comprises at least one urethane acrylate. Urethane acrylates have been shown to impart improved toughness to polymers, and also have a history of use in shape memory polymers and a record of proven biocompatibility (Liu et al., 2007, J. Mat. Chem. 17:1543-58; Meng & Hu, 2008, Composites A 39:314-21; Meng & Hu, 2009, Composites: Part A, Memory, 40:1661-72; Xu et al., 2006, Polymer 47:457-65). In another embodiment, the urethane acrylate is Eb220, Eb230, Eb1290, Eb8402, or a combination thereof.

In one embodiment, the composition of the invention may further comprise a polymerization accelerator. A non-limiting example of a polymerization accelerator is an amine accelerator. Examples of amine accelerators suitable for use are the various organic tertiary amines well known in the art, such as triethylamine, diisopropylethylamine, pyridine, EDAB, 2-[4-(dimethylamino)phenyl]ethanol, N,N-dimethyl-p-toluidine (DMPT), bis(hydroxyethyl)-p-toluidine, triethanolamine, and the like. Another non-limiting example of an accelerator is dimethylphenylphosphine (DMPP). The accelerators are generally present at about 0.5 to about 4.0 wt % in the polymeric component.

In one embodiment, the composition of the invention may further comprise a polymerization photoinitiator. Any radical photoinitiator known in the art may be employed, such as benzoin ethers and phenone derivatives such as benzophenone or diethoxyacetophenone. Non-limiting examples contemplated within the invention are bis-(2,4,6-trimethylbenzoyl)-phenylphosphineoxide (IR 819), 1-hydroxycyclohexyl benzophenone (IR 814), trimethyl-benzoyl-diphenyl-phosphine-oxide (IR TPO), 3-methylacetophenone, xanthone, flurenone, fluorene, 2-hydroxy-2-methyl-1-phenylpropan-1-one, thioxanethone, diethylthioxanthone, 2,2-dimethoxy-2-phenyl-acetophenone, benzyl methyl ketal, and 2,4,6-trimethylbenzoyldiphenyl-phosphine. Photoinitiators may be used in amounts ranging from about 0.01 to about 5 weight percent (wt %).

In an embodiment, if photopolymerization using visible light is desired, camphorquinone (CQ) and ethyl 4-dimethylaminobenzoate (EDAB), both available from SigmaAldrich (Milwaukee, Wis.) may be used as an initiator. Alternatively, if ultraviolet photopolymerization is desired, 2,2-dimethoxy-2-phenyl-acetophenone (DMPA, Ciba-Geigy, Hawthorn, N.J.) may be used as an initiator.

In one embodiment, the composition of the invention may further comprise an inhibitor, such as N-nitrosophenylhydroxylamine, hydroquinone, methoxy hydroquinone, tert butyl catechol, or pyrogallol. In one aspect, the inhibitors prevent the acrylate monomer photopolymerization from occurring before being activated by light. The inhibitor may be presented in an amount selected from about 1 ppm to about 100,000 ppm.

In one embodiment, the composition of the invention may further comprise a filler. Non-limiting examples of a filler contemplated within the invention include a silica particle, Kevlar veil, PET mesh, fiber mesh, metal mesh, Multi-Walled Carbon NanoTube (MWCNTs), Carbon NanoTube (CNTs), organoclay, clays, alumina, titania, zirconia, carbon, bioglass (or bioactive glasses), hydroxyapatite (HA) particle/mesh, quartz, barium glass, barium salt, and titanium dioxide. In one embodiment, the filler ranges from about 0% to about 60% volume in the composition.

The invention also includes a composition comprising at least one nucleophilic monomer, at least one isocyanate monomer, and at least one acrylate monomer. In one embodiment, the nucleophilic monomer comprises a thiol monomer or alcohol monomer.

In one embodiment, the amounts of the at least one nucleophilic monomer and the at least one isocyanate monomer in the composition of the invention are such that the nucleophile equivalent concentration ranges from about 2:1 to about 1:2 with respect to the isocyanate equivalent concentration. In another embodiment, the nucleophile equivalent concentration ranges from about 2:1 to about 1:1 with respect to the isocyanate equivalent concentration. In yet another embodiment, the nucleophile equivalent concentration ranges from about 1:1 to about 1:2 with respect to the isocyanate equivalent concentration. In yet another embodiment, the nucleophile equivalent concentration is about 1:1 with respect to the isocyanate equivalent concentration. In yet another embodiment, the ratio of the nucleophile equivalent concentration to the isocyanate equivalent concentration in the composition ranges from about 0.9 to about 1.1. In yet another embodiment, the ratio of the nucleophile equivalent concentration to the isocyanate equivalent concentration in the composition ranges from about 0.95 to about 1.05. In yet another embodiment, the ratio of the nucleophile equivalent concentration to the isocyanate equivalent concentration in the composition is about 1.

The nucleophile monomer contemplated within the invention has at least two nucleophilic groups per molecule, wherein each nucleophilic group is independently an alcoholic hydroxyl, phenolic hydroxyl or thiol.

Non-limiting examples of alcohol monomers contemplate within the invention include ethylene glycol, diethylene glycol, triethylene glycol, tetrethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexane-dimethanol, methyldiethanolamine, phenyldiethanolamine, trimethylolpropane, 1,2,6-trihexanetriol, triethanolamine, pentaerythritol, N,N,N′,N′-tetrakis(2-hydroxypropyl) ethylenediamine, poly(tetramethylene ether)glycol, 1,4-butanediol, glycerol, polycarbonate polyols, polycaprolactone polyols, polybutadiene polyols, and polysulfide polyols.

In one embodiment, the composition further comprises a urethane acrylate. In another embodiment, the urethane acrylate is Eb220, Eb230, Eb1290 or Eb8402.

### Methods of the Invention

The invention includes a method of generating a given polymer, comprising the step of providing an initial composition comprising a first polymerizable composition and a second polymerizable composition, wherein the first polymerizable composition undergoes polymerization when submitted to a first polymerization reaction condition, wherein the second polymerizable composition undergoes polymerization when submitted to a second polymerization reaction condition, wherein the first and second polymerization reaction conditions are orthogonal to each other. The method further comprises submitting the initial composition to the first polymerization reaction condition to promote polymerization of the first polymerizable composition, thereby forming an intermediate composition. The method further comprises submitting the intermediate composition to the second polymerization reaction condition to promote polymerization of the second polymerizable composition, thereby forming the given polymer.

The first and second polymerization reaction conditions are orthogonal to each other. When the initial composition of the invention is submitted to the first polymerization reaction, the one or more first polymerizable monomers undergo polymerization to a given extent. Under the conditions of this first polymerization reaction, the one or more second polymerizable monomers undergo less than 90% polymerization, preferably less than 70% polymerization, more preferably less than 50% polymerization, more preferably less than 30% polymerization, more preferably less than 10% polymerization, most preferably less than 5% polymerization. When the intermediate composition of the invention is submitted to the second polymerization reaction, the one or more second polymerizable monomers undergo polymerization to a given extent. Such composition may be used within the methods of the invention, following modifications that are easily identified and implemented by those skilled in the art. It is therefore to be understood that the present invention may be presented otherwise than as specifically described herein without departing from the spirit and scope thereof.

In one embodiment, the first polymerization reaction consumes about 100% of the reactive groups that could be consumed in that reaction. In another embodiment, the first polymerization reaction consumes less than about 100% of the reactive groups that could be consumed in that reaction. In yet another embodiment, the second polymerization reaction consumes about 100% of the reactive groups that could be consumed in that reaction. In yet another embodiment, the second polymerization reaction consumes less than about 100% of the reactive groups that could be consumed in that reaction.

The invention includes a method of generating a given polymer. The method includes the step of providing an initial composition comprising a polymerization photoinitiator, at least one acrylate monomer, and a component selected from the group consisting of: (a) at least one thiol monomer, wherein the ratio of the thiol equivalent concentration of the at least one thiol monomer in the initial composition and the acrylate equivalent concentration of the at least one acrylate monomer in the initial composition ranges from about 0.05 to about 0.95; and (b) a mixture of at least one nucleophile monomer and at least one isocyanate monomer, wherein the ratio of the nucleophile equivalent concentration of the at least one nucleophilic monomer in the initial composition and the isocyanate equivalent concentration of the at least one isocyanate monomer in the initial composition ranges from about 2:1 to about 1:2, and wherein the at least one nucleophile monomer comprises a thiol monomer or an alcohol monomer. The method further includes the step of shaping the initial composition into a shape. The method further includes the step of submitting the initial composition to a reaction condition whereby a reaction selected from the group consisting of: (a) a reaction between the at least one acrylate monomer and the at least one thiol monomer, and (b) a reaction between the at least one nucleophile monomer and the at least one isocyanate monomer; takes place to form an intermediate composition, wherein the intermediate composition comprises unreacted acrylate monomer. The method further includes the step of submitting the intermediate composition to a reaction condition whereby photopolymerization of the unreacted acrylate monomer takes place to form the given polymer, wherein the given polymer has enhanced mechanical properties over the intermediate composition.

The invention further includes a method of preparing a polymer pad with a given imprint. The invention comprises the step of providing an initial composition comprising a polymerization photoinitiator, at least one acrylate monomer, and a component selected from the group consisting of: (a) at least one thiol monomer, wherein the ratio of the thiol equivalent concentration of the at least one thiol monomer in the initial composition and the acrylate equivalent concentration of the at least one acrylate monomer in the initial composition ranges from about 0.05 to about 0.95; and, (b) a mixture of at least one nucleophile monomer and at least one isocyanate monomer, wherein the ratio of the nucleophile equivalent concentration of the at least one nucleophilic monomer in the initial composition and the isocyanate equivalent concentration of the at least one isocyanate monomer in the initial composition ranges from about 2:1 to about 1:2, and wherein the at least one nucleophile monomer comprises a thiol monomer or an alcohol monomer. The invention further comprises the step of shaping the initial composition into a given shape. The invention further comprises the step of submitting the initial composition to a reaction condition whereby a reaction selected from the group consisting of: (a) a reaction between the at least one acrylate monomer and the at least one thiol monomer, and, (b) a reaction between the at least one nucleophile monomer and the at least one isocyanate monomer; takes place to form an intermediate composition, wherein the intermediate composition comprises unreacted acrylate monomer. The invention further comprises the step of pressing the intermediate composition into a master pattern block, wherein the master pattern block comprises the negative image of the given imprint. The invention further comprises the step of submitting the intermediate composition to a reaction condition whereby photopolymerization of the unreacted acrylate monomer takes place to form the polymer pad with the given imprint.

The invention further includes a method of preparing an optical device. The invention comprises the step of providing an initial composition comprising a polymerization photoinitiator, at least one acrylate monomer, and a component selected from the group consisting of: (a) at least one thiol monomer, wherein the ratio of the thiol equivalent concentration of the at least one thiol monomer in the initial composition and the acrylate equivalent concentration of the at least one acrylate monomer in the initial composition ranges from about 0.05 to about 0.95; and, (b) a mixture of at least one nucleophile monomer and at least one isocyanate monomer, wherein the ratio of the nucleophile equivalent concentration of the at least one nucleophilic monomer in the initial composition and the isocyanate equivalent concentration of the at least one isocyanate monomer in the initial composition ranges from about 2:1 to about 1:2, and wherein the at least one nucleophile monomer comprises a thiol monomer or an alcohol monomer. The method further includes the step of shaping the initial composition into a given shape. The method further includes the step of submitting the initial composition to a reaction condition whereby a reaction selected from the group consisting of: (a) a reaction between the at least one acrylate monomer and the at least one thiol monomer, and, (b) a reaction between the at least one nucleophile monomer and the at least one isocyanate monomer; takes place to form an intermediate composition, wherein the intermediate composition comprises unreacted acrylate monomer. The method further includes the step of writing refractive index gradients into the intermediate composition. The method further includes the step of submitting the intermediate composition to a reaction condition whereby photopolymerization of the unreacted acrylate monomer takes place to form the optical device.

In one embodiment, the ratio of the nucleophile equivalent concentration of the at least one nucleophilic monomer in the initial composition and the isocyanate equivalent concentration of the at least one isocyanate monomer in the initial composition is about 1:1. In another embodiment, the ratio of the nucleophile equivalent concentration of the at least one nucleophilic monomer in the initial composition and the isocyanate equivalent concentration of the at least one isocyanate monomer in the initial composition ranges from about 2:1 to about 1:1. In yet another embodiment, the ratio of the nucleophile equivalent concentration of the at least one nucleophilic monomer in the initial composition and the isocyanate equivalent concentration of the at least one isocyanate monomer in the initial composition ranges from about 1:1 to about 1:2.

In one embodiment, the at least one thiol monomer is selected from the group consisting of 2,5-dimercaptomethyl-1,4-dithiane, 2,3-dimercapto-1-propanol, 2-mercapto-ethyl sulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, and isophorone diurethane thiol. In another embodiment, the at least one thiol monomer is selected from the group consisting of pentaerythritol tetra-(3-mercaptopropionate), trimethylol propane tris(3-mercaptopropionate) and isophorone diurethane thiol.

In one embodiment, the at least one acrylate monomer is selected from the group consisting of ethylene glycoldi(meth)acrylate, tetraethyleneglycol-di(meth)acrylate, poly(ethylene glycol)dimethacrylates, the condensation product of bisphenol A and glycidyl methacrylate, 2,2′-bis[4-(3-methacryloxy-2-hydroxypropoxy)-phenyl]propane, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl(meth)acrylate trimethylolpropane triacrylate and tricyclodecane dimethanol diacrylate. In another embodiment, the at least one acrylate monomer is selected from the group consisting of trimethylolpropane triacrylate and tricyclodecane dimethanol diacrylate.

In one embodiment, the ratio of the thiol equivalent concentration of the at least one thiol monomer in the initial composition and the acrylate equivalent concentration of the at least one acrylate monomer in the initial composition ranges from about 0.5 to about 0.95. In one embodiment, the ratio ranges from about 0.3 to about 0.4. In yet another embodiment, the ratio is about 0.33.

In one embodiment, the initial composition further comprises an accelerator. In another embodiment, the accelerator is triethylamine or dimethylphenylphosphine.

In one embodiment, the initial composition further comprises a compound selected from the group consisting of an accelerator and a urethane based acrylate. In another embodiment, the initial composition further comprises a urethane based acrylate.

In one embodiment, the initial composition further comprises a polymerization photoinitiator. In another embodiment, the polymerization photoinitiator is 2,2-dimethoxy-1,2-diphenylethan-1-one, bis(2,4,6-trimethylbenzoyl)-phenyl-phosphineoxide, 1-hydroxycyclohexyl benzophenone, or trimethyl-benzoyl-diphenyl-phosphine-oxide. In another embodiment, the photopolymerization is promoted by UV radiation.

In one embodiment, the initial composition further comprises at least one high-refractive index acrylate. In another embodiment, the at least one high-refractive index acrylate is 2,4,6-tribromophenyl acrylate. In yet another embodiment, the writing in the intermediate composition is performed with patterned light in given features. In yet another embodiment, the given features range in dimension from about 25 μm to about 200 μm.

Although the invention has been described in its preferred form with a certain degree of particularity, obviously many changes and variations are possible therein and will be apparent to those skilled in the art after reading the foregoing description. Such changes and variations are considered to be part of the invention described and claimed therein. In a non-limiting embodiment, the composition of the invention may comprise a first composition and a second composition. The first composition comprises one or more first polymerizable monomers that are at least partially polymerized by a first given polymerization reaction condition. The second composition comprises one or more second polymerizable monomers that are at least partially polymerized by a second given polymerization reaction condition. The first and second polymerization reaction conditions may independently comprise any known polymerization reaction condition that results in polymerization of the monomers, including chemical reagents, electromagnetic radiation, physical treatment or incubation under given conditions.

When the composition of the invention is submitted to the first polymerization reaction condition, the one or more first polymerizable monomers undergo polymerization to a given extent. Under the conditions of this first polymerization reaction condition, the one or more second polymerizable monomers undergo less than 90% polymerization, preferably less than 70% polymerization, more preferably less than 50% polymerization, more preferably less than 30% polymerization, more preferably less than 10% polymerization, most preferably less than 5% polymerization. When the composition of the invention is submitted to the second polymerization reaction condition, the one or more second polymerizable monomers undergo polymerization to a given extent. In this way, the first and second polymerization reaction conditions are orthogonal. Such composition may be used within the methods of the invention, following modifications that are easily identified and implemented by those skilled in the art. It is therefore to be understood that the present invention may be presented otherwise than as specifically described herein without departing from the spirit and scope thereof.

### Fillers

Although polymers can be tailor-made to exhibit a wide range of properties and fabricated into complex shapes and structures, they may require the use of fillers to meet the mechanical demands of applications such as aerospace materials, which require a high strength to weight ratio (Breuer & Sundararaj, 2004, Poly. Comp. 24:630; Vajtai et al., 2002, Smart Mat. Struct. 11:691). Polymer composites afford much of the same ease of processing and low costs that are inherent to polymers, along with the ability to achieve different properties by varying the filler material and quantity. Polymer composites may be engineered to be light weight, with properties such as high strength, stiffness and increased electrical conductivity (McCarthy & Haines, 1994, Comp. Man. 5:83; Jacob et al., 2002, J. Comp. Mat. 36:813).

The invention contemplates the use of fillers within the compositions of the invention. Non-limiting examples of a filler useful within the compositions and methods of the invention are a silica particle, Kevlar veil, PET mesh, fiber mesh, metal mesh, Multi-Walled Carbon NanoTube (MWCNTs), Carbon NanoTube (CNTs), organoclay, clays, alumina, titania, zirconia, carbon, bioglass (or bioactive glass), hydroxyapatite (HA) particle/mesh, quartz, barium glass, barium salt, and titanium dioxide. In a non-limiting embodiment, the filler improves the mechanical properties of the compositions of the invention, such as but not limited to, increasing the rubbery modulus in a state 1 and/or stage 2 composition. In another non-limiting embodiment, the filler has minimal effect on the glass transition temperatures of the compositions of the invention.

### Shape Memory Polymer

### First Stage of Cure Procedure

In a non-limiting example, the invention includes a composition comprising at least one thiol monomer and at least one acrylate monomer. In one embodiment, the composition of the invention undergoes a first polymerization procedure (or a first stage of the cure procedure), wherein the at least one thiol monomer reacts with the at least one acrylate monomer via a Michael addition to form a first cross-linked polymeric product. The Michael addition comprises the addition of a sulfhydryl group of the thiol monomer to the beta carbon of an acrylate group of the acrylate monomer, thereby forming a beta-substituted propionate group in the cross-linked product.

In another non-limiting example, the invention includes a composition comprising at least one nucleophilic monomer, at least one isocyanate monomer, and at least one acrylate monomer. In one embodiment, the composition of the invention undergoes a first polymerization procedure whereby the nucleophile monomer reacts with the isocyanate monomer to form covalent bonds, yielding a urethane, when the nucleophile monomer is an alcohol monomer, or a thiourethane, when the nucleophile monomer is a thiol monomer.

The thiol-acrylate Michael addition polymerization may be catalyzed by a nucleophilic catalyst such as triethylamine (TEA). In a non-limiting aspect, the amine deprotonates the thiol to form a thiolate, which reacts with the electron deficient acrylate. The rate of the reaction may be controlled by increasing the catalyst concentration. Also, higher temperatures maintained during the thiol-acrylate reaction may lead to shorter cure times.

Polymerization kinetics of the first stage of the cure procedure may be determined by monitoring the conversion of functional groups. Conversion is defined as the consumption of thiol or acrylate functional groups upon polymerization. Specifically, upon polymerization, the double-bond of the acrylate group is converted to a saturated ethane by reaction with a thiol (—SH) group. Polymerization kinetics may be monitored by infrared spectroscopy (IR). Fourier Transform IR (FTIR) may be used to study the polymerization kinetics of the reaction, as described in Cramer et al., 2001, J. Poly. Sci. Part A: Polymer Chem. 39:3311-19. For example, the infrared peak absorbance at 2,572 cm⁻¹ may be used for the thiol group conversion. Conversions may be calculated by measuring the ratio of peak areas to the peak area prior to polymerization.

In the composition of the invention, the thiol equivalent concentration is sub-stoichiometric with respect to the acrylate equivalent concentration, and therefore the first cross-linked polymeric product comprises a thiol-acrylate polymer network with residual unreacted acrylate functional groups.

### Second Stage of Cure Procedure

As mentioned above, the polymeric product generated by the first stage of the cure procedure comprises unreacted acrylate functional groups. These residual acrylate functional groups may be induced to homopolymerize on cue in a second polymerization reaction. In one embodiment, the second stage cure is performed via photopolymerization initiated with typical photoinitiators. This results in highly cross-linked polymers with increased glass transition temperatures (T_{g2}) and rubbery moduli. At body temperature, the modulus of the polymer device at the end of the second stage of the cure process is considerably higher than the modulus at the end of the first stage of the cure process. This shape memory polymer system thus can handle high strains and deformation at the end of the first stage of the cure process, and has high modulus and stiffness at the end of the second stage of the cure process, once the device has been deployed in its target location.

In one embodiment, the radical initiated photopolymerization may be photoinitiated by any range within the ultraviolet (about 200 nm to about 400 nm) and/or visible light spectrum (about 380 nm to about 780 nm). The choice of the wavelength range may be determined by the photoinitiator employed. In one aspect, a full spectrum light source such as a quartz-halogen xenon bulb may be utilized for photopolymerization. In another aspect, a wavelength range of about 320 nm to about 500 nm is employed for photopolymerization.

In one aspect, to achieve these two distinct stages within the device, an initial Michael addition reaction with an excess of acrylate to thiol functional groups forms a shape memory polymer network with initial properties such as glass transition temperature T_{g1}. For biomedical applications, it is desirable for T_{g1} to be in the range of 20-60° C. Once the shape memory device has been deployed and is in place, in a second reaction, the remaining acrylate functional groups are photopolymerized. The ensuing polymer exhibits a second set of material properties consisting of a second glass transition temperature T_{g2}, where T_{g2}>T_{g1} and consequently a polymer with a higher modulus is obtained. The two reactions are orthogonal to each other. A wide range of initial and final network properties may be achieved as well as numerous applications for this type of dual-cure system.

### Characterization Methods

Dynamic mechanical analysis (DMA) may be used to measure the mechanical properties of material of the invention as a function of time, temperature and frequency. Stress is a measure of the average amount of force exerted per unit area. Strain is the deformation of a physical body under the action of applied forces. The modulus is considered the change in stress divided by the change in strain of a loaded material specimen within its elastic (non-yielded) range. For example, the modulus is proportional to force divided by the change in length. The modulus may be considered a measure of a material's stiffness. During heating a large loss of modulus occurs over the glass transition region. Material over the T_{g} is “rubbery.” The modulus of the rubbery material is directly related to the crosslink density. Components of material stiffness are separated into a complex modulus and a rubbery modulus.

Samples for dynamic mechanical analysis (DMA) may be tested on, for instance, a Q800 TA Instruments (Newcastle, Del.). DMA studies may be conducted over a temperature range of, for example, −50 to 120° C., with a ramping rate of 5° C./min using extension mode (sinusoidal stress of 1 Hz frequency) and the loss tangent peak can be monitored as a function of temperature. The loss tangent is defined as the polymer's loss modulus divided by storage modulus. During a DMA test, loss tangent peak corresponds to the viscoelastic relaxation of polymer chain or segments. The glass transition temperature may be determined by the maximum of the loss tangent vs. the temperature curve. Normally, the largest loss tangent peak may be associated with the polymer's glass transition peak, and the temperature of the loss tangent peak maximum may be used to define glass transition temperature (T_{g}). The glass transition temperature is the point where a substance changes from a hard-glassy material, to a soft-rubbery one. In monomer or thermoplastic polymers, the transition is from a solid or glass to a flowable liquid. For cross-linked thermosetting polymers, the transition is to a soft-rubbery composition and tends to occur across a thermal band rather than at a distinct point of temperature. At the glass transition temperature, several easily measurable properties such as volume, dimension, enthalpy, strength and modulus also undergo transitions, and are often used to determine T_{g}'s. The T_{g} is determined predominantly by the backbone structure of the polymer.

### Lithographic Impression Materials

The polymers of the invention may be used to manufacture small devices at low cost. Since they are photopolymerizable and show low viscosity and low shrinkage, they form stable polymer networks that enable mold removal without loss of detail. As an alternative to Nano Imprint Lithography (NIL), which requires high temperature for imprinting a pattern with nano-scale resolution, Step and Flash Imprint Lithography (SFIL) may be used for replicating intricate patterns in ambient conditions. In this process, UV light is used to cure the polymer resin while it is being pressed against the pattern block with sub-micrometer resolution (Khire et al., 2008, Adv. Mat. 20(17):3308-13; Rowland & King, 2005, Appl. Phys. A: Mat. Sci. & Proc. 81(7):1331-35).

Free-radical polymerization induced via UV exposure, such as the second stage contemplated within the methods of the invention, has been shown to successfully replicate patterns with nanoscale resolution. SFIL normally consists of pouring a liquid resin onto the pattern that is to be replicated and UV curing the resin on the patterned master. Once the polymer is cured, the thin film is peeled off the master pattern. This technique is cost-effective, allowing multiple nano-imprints to be made from the same master pattern. In a non-limiting example, this dual-cure approach when applied to dental impression materials offers the advantages of low shrinkage stresses, molecular weight control, and delayed gelation, along with the option of terminal functional group tunability.

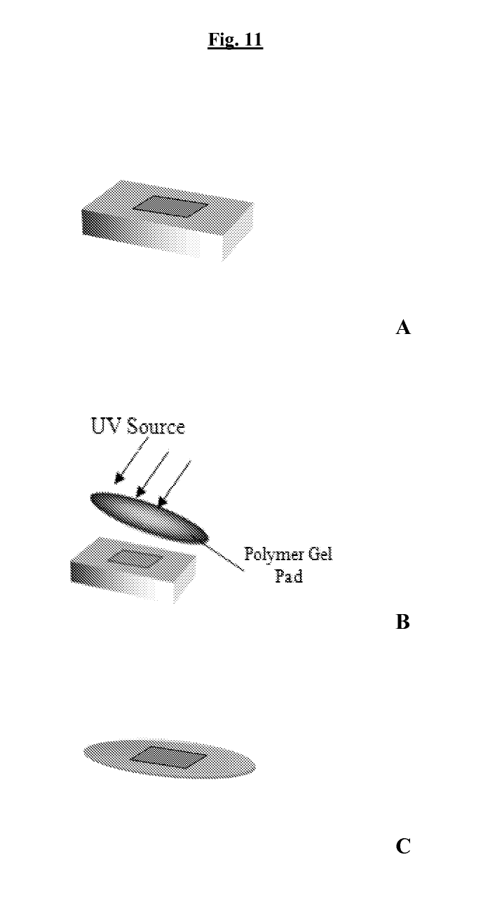

In one aspect, the compositions of the invention comprising the thiol-acrylate network may be utilized to yield a first stage polymer gel that is used as an imprint material. As opposed to a liquid resin mix, the semi-rigid first stage material makes the polymer impression material easier to handle and process. The gel is pressed against the master pattern in ambient conditions and then exposed to a UV source, where the second stage reaction is initiated. Once the gel is cured, the polymer can be pealed-off the master pattern, whereby an imprint of the pattern is obtained. The process is exemplified in FIG. 11.

### Optical Materials

Compositions of the invention may be used to manufacture optical materials, such as contact lenses. An exemplary application for this technology is the manufacture of contact lenses for patients that require higher order vision corrections. For optical applications, the first stage curing is formed in the shape of a lens. The first stage polymer may then be submitted to refractive index patterning. In a non-limiting example, the wavefront of a subject's eyes is measured, the ideal correction is determined (including higher order vision corrections), and the proposed material is subjected to a second stage cure to develop an optically complex lens. This lens should allow for a significantly enhanced vision relative to any conventional correction methodology.

In a non-limiting example of the preparation of an optical system within the methods of the present invention, a composition comprising a 3:1 ratio of acrylate to thiol functional groups is used. In one embodiment, the composition further comprises PETMP, TCDDA and Ebe1290. In another embodiment, the composition further comprises 2,4,6-tribromophenyl acrylate, which has a high refractive index. In yet another embodiment, the formulation comprises 5 wt % 2,4,6-tribromophenyl acrylate. In yet another embodiment, the formulation further comprises 0.8 wt % triethylamine, which catalyzes first stage curing. In yet another embodiment, the composition comprises 1.0 wt % Irgacure™ 651, to enable photoinitiated second stage curing. After first stage curing, partial waveguides are written into the material, generating refractive index variations that may be patterned into a material by light exposure. In yet another embodiment, the second stage curing may be carried out by ultraviolet irradiation, such as irradiating with 8 mW/cm² UV light.

In one embodiment, a high refractive index monomer, such as but not limited to 2,4,6-tribromophenyl acrylate, is incorporated to facilitate writing areas with higher refractive index than the base system thereby generating refractive index gradients. Refractive index gradients may be written into the material using patterned light with 25 μm-200 μm features.

### Suture Anchor Systems

Arthroscopy (also called arthroscopic surgery) is a minimally invasive surgical procedure in which an examination and sometimes treatment of damage of the interior of a joint is performed using an arthroscope (a type of endoscope inserted into the joint through a small incision). Arthroscopic procedures may be performed to evaluate or treat orthopedic conditions including torn floating cartilage, torn surface cartilage, ACL reconstruction, and trimming damaged cartilage.

The advantage of arthroscopy over traditional open surgery is that the joint does not have to be opened up fully. Instead, only two small incisions are made—one for the arthroscope and one for the surgical instruments, reducing recovery time and trauma to the connective tissue. Arthroscopic procedures also have improved patient outcomes and lower costs. It is technically possible to do an arthroscopic examination of almost every joint in the human body, such as knee, shoulder, elbow, wrist, ankle, foot, and hip.

Within arthroscopy, the suture anchor works as a staple or straight pin by holding the healing tissues or the soft tissue and bone together to enable reattachment. There are currently more than thirty distinct types of suture anchors available. Unfortunately, despite the best efforts of the surgeons, technical difficulties with the devices and complications related to the surgical procedure and/or the type of device inserted continue to occur. The major complications seen are incorrect device placement, migration after placement, loosening, and device breakage (Park et al., 2006, Am. J. Sports Med. 34:136). Although the anchor design and placement may play a considerable role in minimizing subsequent device failure, the most common reason for device pull-out and migration is the modulus mismatch between the anchor material and the surrounding bone (Tingart et al., 2003, J. Bone Joint. Surg. 85A:2190; Strauss et al., 2009, J. Arthro. Surg. 25:597; Yakacki et al., 2009, J. Ortho. Res. 27:1058). A large difference in modulus between the implant material and the bone also gives rise to the phenomenon of stress shielding, in which the mechanical load is unevenly shared between the bone and the implant (Huiskes et al., 1992, Clin. Orthop. 274:192). In the case that the implant has higher modulus than the bone, the bone is subject to reduced stress, and in accordance with Wolf's law this results in bone mass loss over time and eventual implant failure. Bioabsorbable plastic suture anchors performs as well as non-bioabsorbable plastics in terms of strength, but may not remain in place and retain holding strength enough to facilitate full healing. Recently, a new suture anchor made from polyether ether ketone (PEEK) has obtained FDA approval. Unfortunately, PEEK exhibits the same drawbacks as other SMPs with high modulus. PEEK has a glass transition temperature of 143° C. and therefore is glassy at body temperature and exhibits recoverable strains of less than 10% leading to limited device designs and shape memory properties.

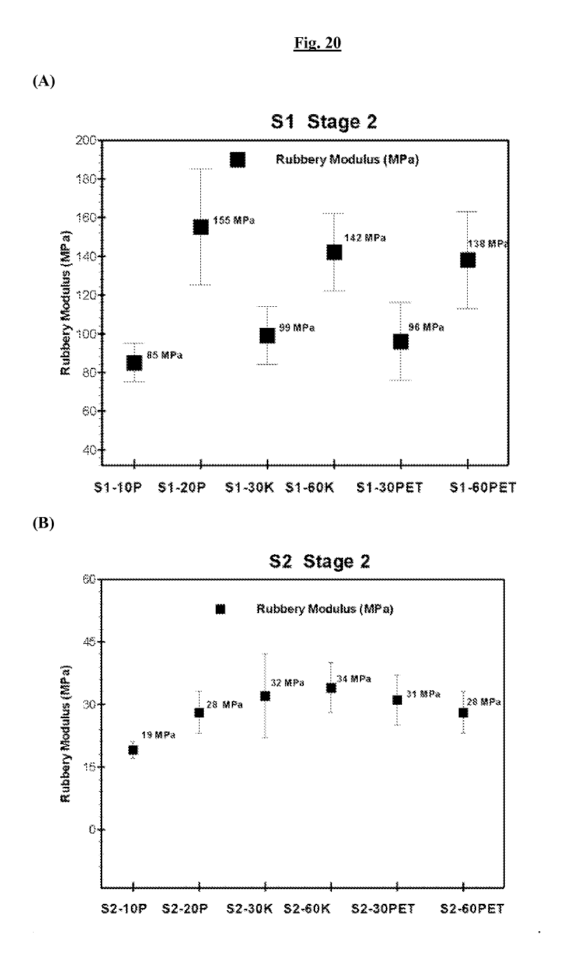

The local quality of the bone into which the device is anchored can vary markedly, given that bone modulus and quality depend on factors such as the age, sex and disease (FIG. 21). Further, the yield strength of the bone has also been proposed as a marker for suture anchor pull-out, as loading the bone above this limit would create irreversible bone deformations and eventually lead to device failure (Gualtieri et al., 2000, J. Ortho. Res. 18:494). The bone yield strength is dependent on many factors such as age, sex and bone mineral density (BMD). BMD plays an important role in anchor stability especially in the elderly patients (Chung et al., 2011, J. Sports. Med. 39:2099).

The invention includes a novel two-stage reactive shape memory polymer system that, through simple formulation manipulations, enables previously unachievable properties that are ideal for use in orthopedic implants. In one embodiment, the invention contemplates using compositions of the invention to design and formulate two-stage reactive shape memory polymer (SMP) systems that can be delivered arthroscopically. In one embodiment, a thiol-acrylate SMP network formed by “click” Michael addition reaction with a stoichiometric excess of acrylate groups relative to thiol groups forms stage 1 polymer network. Shape memory materials, as a whole, enable a range of potential biomedical applications, including minimally invasive surgery (MIS) options in which an implant device constrained in its temporary shape within a catheter or cannula can be delivered to a location within the body. In one embodiment, once exposed to body temperature, the device transforms into its permanent shape. After arthroscopic device placement, the residual acrylate functional groups may be photopolymerized in a second polymerization reaction to form a highly crosslinked stage 2 polymer that is designed to match the local bone modulus, thereby minimizing device failures. The key to the application of the two-stage reactive concept is that this approach uniquely enables the polymer material to have two distinct and largely independent sets of material properties—the first allows for device delivery and the second allows for optimum function of the device as a suture anchor.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Materials:

Pentaerythritol tetra(3-mercaptopropionate) (PETMP) was obtained from Evans Chemetics (Teaneck, N.J.). Isophorone diisocyanate (IPDI) was obtained from Bayer (Pittsburgh, Pa.). The photoinitiator Irgacure™ 651 (2,2-dimethoxy-2-phenylacetophenone) was obtained from Ciba Specialty Chemicals (McIntosh, Ala.). The inhibitor aluminum N-nitrosophenylhydroxylamine (N-PAL) was obtained from Albemarle (Baton Rouge, La.). Tricyclodecane dimethanol diacrylate (TCDDA) was obtained from Sartomer Company Inc. (Exton, Pa.). Trimethylol propane tris-(3-mercaptopropionate) (TMPTMP) and triethylamine (TEA) were obtained from Sigma Aldrich (St. Louis, Mo.).

Ebecryl® 220 or Eb-220 (an aromatic urethane hexacrylate; average molecular weight of 1,000), Ebecryl® 230 or Eb-230 (an aliphatic urethane diacrylate; average molecular weight of 5,000), Ebecryl® 1290 or Eb-1290 (an aliphatic urethane hexaacrylate; average molecular weight of 1,000), and Ebecryl® 8402 or Eb-8402 (an aliphatic urethane diacrylate; average molecular weight of 1,000) were obtained from Cytec (Woodland Park, N.J.).

The PET fibers were purchased from Surgical Meshes Inc., and set in the polymer matrix in the cross-machine direction. The Kevlar veil was obtained from Fiber Glass Inc., and the silica particles were donated by Esstech. A FlakTech speed mixer (DAC 150 FVZ) was used to disperse the silica particles within the polymer composite at a speed of 2,500 RPM for 20 seconds.

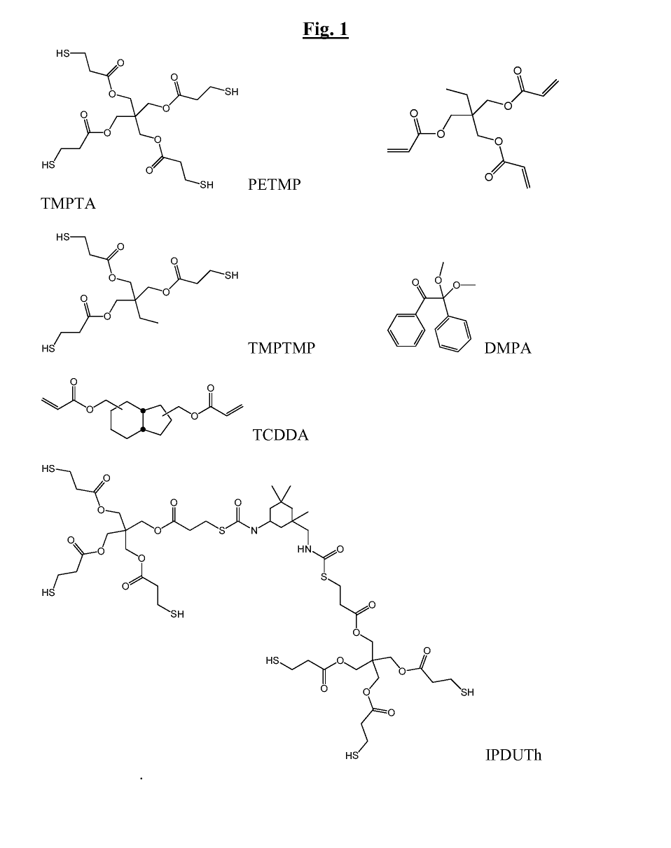

Unless otherwise noted, all remaining starting materials were obtained from commercial suppliers and used without purification. Structures for representative monomers utilized in this study are illustrated in FIG. 1.

### Chemical Synthesis:

Isophorone diurethane thiol (IPDUTh) was synthesized by a procedure adapted from Hoyle and co-workers (Senyurt et al., 2007, Macromolecules 40:3174-82; Hoyle et al., 2010, Chem. Soc. Rev. DOI:10.1039/B901979K).

IPDUTh was synthesized by mixing one equivalent of isophorone diisocyanate with two equivalents of pentaerythritol tetra(3-mercaptopropionate) and 0.05 wt % triethylamine as a catalyst. The mixture was maintained at 60° C. until the isocyanate group reacted to an extent greater than 99%, as determined by monitoring the infrared isocyanate peak at 2,260 cm⁻¹. The reaction formed a series of oligomers with the idealized, average product illustrated in FIG. 1.

The thiol-acrylate systems were mixed with different stoichiometric mixtures of thiol to acrylate functional groups (1:1; 1:1.5; 1:2). The urethane-thiol-acrylate system was also prepared as a 1:12 stoichiometric mixture of thiol to acrylate functional groups for the SMP system and a 1:14 thiol to acrylate stoichiometry for the lithography gel.

In some embodiments, samples contained 0.8 wt % TEA for the first stage reaction, and 0.5-1 wt % Irgacure 651 to initiate the second stage reaction. Some of the samples also contained 0.1 wt % N-PAL, as noted.

For the photopolymerization of the second reaction, samples were cured at 8 mW/cm² using a UV lamp (Black-Ray Model B100AP).

### Polymer Coils:

For the fabrication of polymer coils, a Teflon cylinder was inserted into a tight-fitting glass tube. The monomer mixture was added into the mold and allowed to set for approximately 24 hours. After curing, the glass tube was broken and the polymer was carefully removed from the mold. For second stage curing, coils were photopolymerized using a UV lamp (Black-Ray Model B100AP).

### Dynamic Mechanical Analysis:

Dynamic mechanical analysis (DMA) was performed using a TA Instruments Q800 DMA (New Castle, Del.).

### Glass Transition Temperature Determination:

### Procedure I:

Glass transition temperature (T_{g}) was determined from polymer samples with dimensions such as 10×3.5×1 mm or 15×4×1 mm, wherein values are provided for illustrative purposes only. Sample temperature was ramped at 3° C./min from −50° C. to 65° C. after the first stage of the cure process and −25° C. to 200° C. (or 300° C.) after the second stage of the cure process, with a frequency of 1 Hz and a strain of 0.01% in tension. The T_{g} was assigned as the temperature at the tan δ curve maximum. The rubbery modulus values were determined at a temperature 35° C. above the T_{g}.

### Procedure II:

Glass transition temperature (T_{g}) was determined from polymer samples with dimensions 10×3.5×1 mm. Sample temperature was ramped at 3° C./min from −50° C. to 300° C. with a frequency of 1 Hz and a strain of 0.01% in tension. The T_{g} was assigned as the temperature at the tan δ curve maximum. The rubbery modulus values were determined at a temperature 65° C. above the T_{g}, and the T_{g} was measured as the full width at half height of the tan δ peak.

### Materials Testing System (MTS)

Compression test measurements were conducted on an Instron Universal Testing Machine (Insight 2.0) to ascertain the peak stress, strain at break and toughness measures of the system at the end of stage 1 and stage 2. In a non-limiting example, cylindrical samples of dimensions of 5 mm (diameter)×6.5 mm (height) or 40 mm×6.5 mm×1 mm were used. The initial separation of the system was set at 22 mm and a crosshead speed of 5 mm/min was applied. All data was collected at ambient temperature.

Tensile test measurements were conducted on an Instron Universal Testing Machine (Insight 2.0) to ascertain the tensile modulus and strain at break for the suture anchor systems. For the suture anchor test, the bottom clamp was replaced by machined devise to hold the dog bone in place. Dog bone shaped samples of dimensions 40×6.5×1 mm were used. The initial separation of the system was set at 22 mm and a crosshead speed of 5 mm/min was applied. The stage 2 polymerization of the suture anchor device was done in-situ, within the metal block at 8 mW/cm², using a UV lamp (Black-Ray Model B100AP).

### Free Strain Recovery:

Shape fixity and shape recovery sharpness were determined from fully cured samples with dimensions of 10×51 mm. For the free strain recovery tests, the polymers were held at a temperature 5° C. above the T_{g} of the system and strained in tension between 20 and 40% (always ensuring that they stayed within the linear regime). The maximum strain was noted as εₘ. While maintaining the strain, the polymers were cooled to −25° C. at 20° C. per minute. The force was then maintained at zero and the strain on unloading the polymer was recorded (εᵤ). The strain recovery was observed as the temperature was increased to 25° C. above the T_{g} at the rate of 3° C./min. The final strain of the system post recovery was recorded as εₚ. Free strain recovery was defined as Rᵣ(%)=(εᵣ−εₚ)/(εₘ−εₚ)*100. Shape fixity is given by R_{f}(%)=(εᵤ/εₘ)*100 and shape recovery sharpness defined by vᵣ=Rᵣ/ΔT, where ΔT is a measure of the width of the transition and is the temperature range from the onset of the recovery to its completion.

### Fourier Transform Infrared Spectroscopy (FTIR):

FTIR experiments were performed using a Nicolet Magna 760. Thiol peak absorbance was measured at 2,570-2,575 cm⁻¹, and acrylate peak absorbance was measured at 814 cm⁻¹. Samples were prepared and mounted between salt crystals, and spectra were taken before the addition of initiator (TEA) and the thiol and acrylate peak areas were recorded as Aₜₕᵢₒₗ and A_{acrylate}, respectively. Samples were then prepared with TEA, mounted between salt crystals, and stored for 48 hours to allow substantial time for first stage curing. After 48 hours, spectra were taken, and peak areas for thiol and acrylate were recorded, both before and after exposure to UV light (at 20 mW/cm²) for 5-15 minutes. Thiol conversion was defined as αₜₕᵢₒₗ=1−[(Aₜₕᵢₒₗ)_{t=final}/(Aₜₕᵢₒₗ)ₜ₌ᵢₙᵢₜᵢₐₗ]. Acrylate conversion is given by the formula α_{acrylate}=1−[(A_{acrylate})_{t=final}/(A_{acrylate})ₜ₌ᵢₙᵢₜᵢₐₗ].

### Rheology:

Rheology experiments were performed using a TA Instruments ARES. Samples were prepared on 8 mm parallel geometry plates for dynamic testing. A dynamic time sweep test was performed using a strain of 0.2% and a frequency of 10 Hz, with data points being recorded once every second. The first stage was observed for up to 2 hours after the monomer were mixed and then samples were concurrently exposed to UV light for 10 minutes during testing. Average elastic modulus (G′) was determined both before and after UV exposure.

### Example 1

### Reaction Between Thiol and Acrylate Systems

In this study, a novel non-stoichiometric thiol-acrylate formulation that generates a novel dual-cure shape memory polymer system was identified. In terms of the design of a biomedical device, after the first stage of the cure process, the system has mechanical properties that allow optimum deployment of the device to the body. After the device is installed in the body, the second stage of the cure process may be deployed.

The properties of dual-cure thiol acrylate systems with potential biomedical applications were evaluated as illustrated below. Two different thiol and acrylate systems with different stoichiometric ratios of acrylate to thiol were used. The reaction between a tetra-thiol (PETMP) and a triacrylate (TMPTA), and the reaction between a tri-thiol (TMPTMP) and a triacrylate (TMPTA) were examined The different stoichiometries used had an acrylate to thiol ratio of 1:1 (control), 3:2 and 2:1.

The initial Michael addition reaction was catalyzed by a tertiary amine, resulting in a one-to-one addition of thiol to acrylate. Triethylamine (TEA) acted as a nucleophilic catalyst, initiating Michael addition reactions between the thiol and acrylate functional groups and generating a polymer network in which all of the thiol functional groups completely react with the acrylate groups.

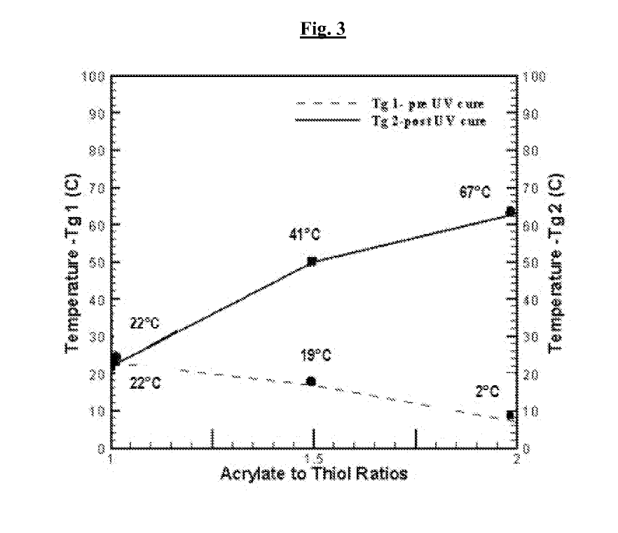

The stoichiometry of the 1:1 thiol to acrylate control system should ideally result in minimal unreacted acrylate functional groups and the highest glass transition temperature (T_{g1}) within each system. Also, as there are no excess acrylate functional groups in systems with a 1:1 stoichiometry, the second stage of the cure process for control should not yield a significantly higher T_{g2} (i.e., T_{g1} should be approximately equal to T_{g2}) as illustrated in FIG. 3.

### Example 2

### Characterization of Polymer Systems

The monomers were mixed in the specified stoichiometric ratios and the first stage of the cure process was carried out at ambient temperature. Twenty-four hours later, the T_{g} of the polymer along with its modulus was measured. The second stage of the cure process was then affected by exposing the polymer to UV light (8 mW/cm²) for up to 20 minutes at ambient temperature. At the end of the second stage of the cure process, the T_{g} and the modulus of the polymer were measured again. The modulus at body temperature was measured by holding the polymer at 38° C. (body temperature) for 45 minutes (Tables 2-6).

Shape memory programming and shape recovery was done by deforming the polymer obtained after the first stage of the cure process into its temporary shape at a temperature T>T_{g}. The polymer was then stored in its temporary shape at temperature T<T_{g}. On being exposed to a temperature T that was greater than the T_{g} of the polymer, its shape recovery was recorded.

The glass transition temperature at the end of the Michael addition was defined as T_{g1}. After exposure to UV light, the second T_{g} (T_{g2}) was also recorded. The rubbery modulus was measured at T_{g}+35° C. The full width of the tan delta curve at half its maximum height was taken to be the width of the glass transition in the systems.

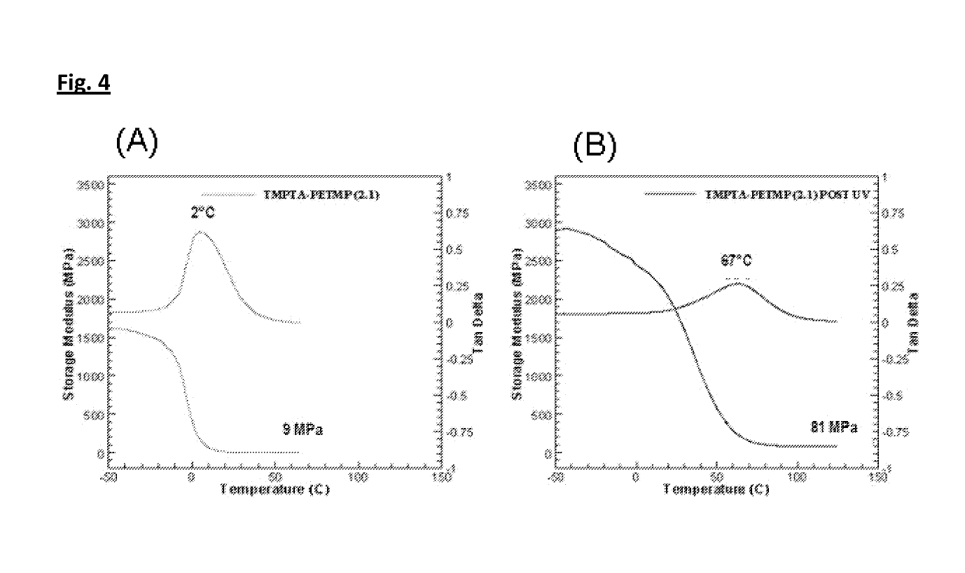

The results suggested that the dual-cure concept yielded thiol-acrylate shape memory systems with distinct T_{g} and rubbery modulus for each stage of the cure process (FIG. 4 for the TMPTA-PETMP system; Table 8 for the TMPTA-TMPTMP system). A dramatic increase in T_{g} and rubbery modulus was indeed observed in the system comprising acrylate and thiol in a ratio of 2:1 (TMPTA and PETMP). The rubbery modulus of the system, which was a direct measure of the crosslinking present in the polymer, showed a nine-fold increase after the second stage of the cure process (Table 2).

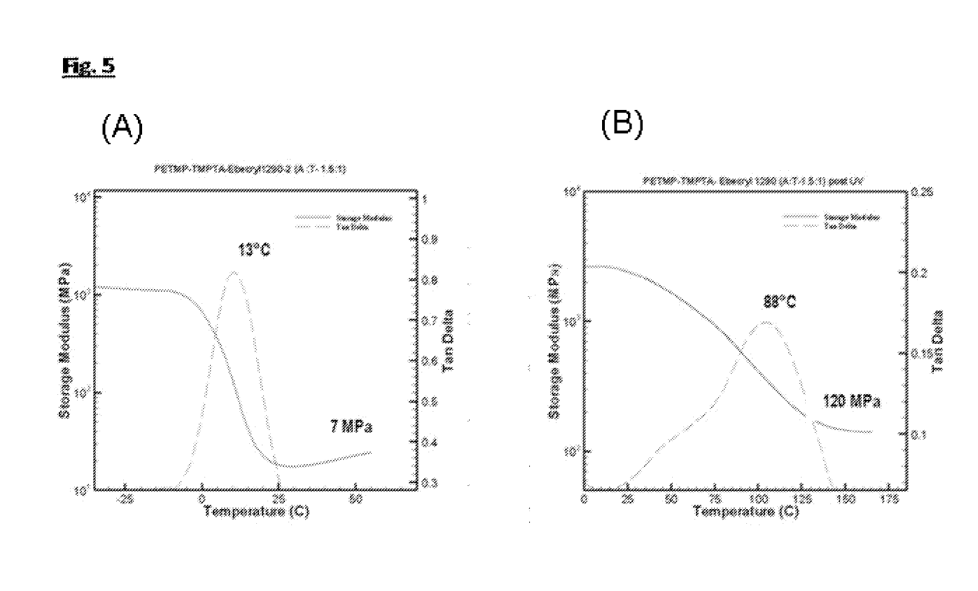

The polymer at the end of the first stage of the cure process for the systems initially evaluated was relatively weak and broke easily during handling. In order to achieve a robust polymer system at the end of the first stage of the cure process, systems consisting of urethane based thiols and urethane acrylates were evaluated, such as a system comprising urethane acrylate Ebecryl® 1290, TMPTA and PETMP, wherein the acrylate to thiol ratio was 1.5:1. The urethane-based shape memory polymer systems were extremely robust and yielded strong, flexible polymers at the end of the first stage of the cure process (FIG. 5). A second stage of the cure process still yielded a highly crosslinked polymer system with a modulus of 1.5 GPa at body temperature and a rubbery modulus of 120 MPa (Table 5).

Table 7 illustrates two systems prepared within the methods of the invention. The first system comprised trimethylolpropane triacrylate (TMPTA) and pentaerythritol tetra(3-mercaptopropionate) (PETMP), and the second system comprised tricyclodecane dimethanol diacrylate (TCDDA), Ebecryl®1290 (an aliphatic urethane hexaacrylate), and PETMP. Both systems utilized a 2:1 ratio of acrylate to thiol functional groups, and contained 0.8 wt % triethylamine for the first stage of the curing process and 1.0 wt % Irgacure 651 for the second stage of the curing process. Both samples were irradiated at 5 mW/cm² ultraviolte light for the second stage of the curing process.

In each case, the material exhibited a low T_{g} (2 and 24° C., respectively) and modulus (9.4 and 11 MPa, respectively) and modulus (1,080 and 2,050 MPa, respectively) at the end of the second stage of the cure process.

The experiments described hereby have characterized novel shape memory polymer systems that overcomes an intrinsic disadvantage of SMPs in biomedical applications (namely lower mechanical properties and moduli in the rubbery regime), without compromising favorable shape memory characteristics of the polymer system. The high-strain shape memory system, having undergone the first stage of the cure process, may be engineered and delivered to the body. Once installed in the body, its mechanical properties such as desirable modulus and stiffness may be achieved in-situ (via photopolymerization, for example). The modulus of the polymer device at body temperature after the second stage of the cure process is considerably higher than the modulus of the polymer device at the end of the first stage of the cure process. Hence the shape memory polymer system has the capacity for high strains and deformation at the end of the first stage of the cure process, and high modulus and stiffness at the end of the second stage of the cure process (performed once the device has been deployed in its target location). The polymer of the invention thus embodies an optimum set of properties for deployment into the body and a second set of properties achieved thereafter.

TABLE 2
Rubbery modulus and glass transition temperatures attained at
the end of Stage 1 and Stage 2 for the PETMP/TMPTA dual-
cure polymer systems, as determined using DMA. Rubbery
modulus was measured at Tg + 35° C. at Stage 1
end and Tg + 65° C. at Stage 2 end (1 wt %
IR651 and 0.8 wt % TEA; post cure at 8 mW/cm²)

| | | Stage 1 | | | |
|---|---|---|---|---|---|
| | Thiol- | | Rubbery | Stage 2 | |
| | Acrylate | T_{g} | Modulus | T_{g} | Rubbery |
| Formulation | Ratio | (° C.) | (MPa) | (° C.) | Modulus (MPa) |
| PETMP/ | 1:1 | 22 ± 3 | 22 ± 5 | 22 ± 2 | 20 ± 5 |
| TMPTA | 1.5:1 | 9 ± 3 | 14 ± 2 | 41 ± 6 | 45 ± 10 |
| | 2:1 | 2 ± 1 | 9 ± 1 | 67 ± 2 | 81 ± 6 |

TABLE 3
Rubbery modulus and glass transition temperatures attained at the
end of Stage 1 and Stage 2 for the PETMP/TCDDA dual-cure
polymer systems, determined using DMA. The rubbery modulus was
measured at Tg + 35° C. at stage 1 end and Tg + 65° C. at Stage 2
end (1 wt % IR651 and 0.8 wt % TEA; post cure at 8 mW/cm²)

| | | | | Stage 2 | |
|---|---|---|---|---|---|
| | Thiol- | Stage 1 | | | Rubbery |
| | Acrylate | T_{g} | Rubbery | T_{g} | Modulus |
| Formulation | Ratio | (° C.) | Modulus (MPa) | (° C.) | (MPa) |
| PETMP/ | 1:1 | 16 ± 2 | 7 ± 1 | 15 ± 1 | 8 ± 1 |
| TCDDA | 1.5:1 | 4 ± 2 | 5 ± 1 | 27 ± 3 | 16 ± 2 |
| | 2:1 | −6 ± 2 | 2 ± 1 | 46 ± 2 | 23 ± 1 |

TABLE 4
1 wt % IR651 and 0.8 wt % TEA -
post cure at 8 mW/cm² with 0.1 wt % N-PAL

| | | | | | | 2^{nd} |
|---|---|---|---|---|---|---|
| | | | | | | stage |
| | | | | | | mod- |
| | T_{g} | 1^{st} stage | 1^{st} stage | T_{g} | 2^{nd} stage | ulus |
| | 1^{st} | rubbery | modulus | 2^{nd} | rubbery | (MPa) |
| IPDUT- | stage | modulus | (MPa) at | stage | modulus | at |
| TMPTA | (° C.) | (MPa) | 38° C. | (° C.) | (MPa) | 38° C. |
| 1.5:1 | 28 ± 2 | 10 ± 1 | 10 ± 1 | 56 ± 5 | 20 ± 4 | 176 ± |
| | | | | | | 30 |
| 2:1 | 7 ± 3 | 5 ± 2 | 5 ± 2 | 106 ± 2 | 83 ± 4 | 1940 ± |
| | | | | | | 130 |

TABLE 5
1 wt % IR651 and 0.8 wt % TEA - post cure at 8 mW/cm²

| | | 1^{st} stage | 1^{st} stage | | 2^{nd} stage | 2^{nd} stage |
|---|---|---|---|---|---|---|
| | T_{g} | rubbery | modulus | T_{g} | rubbery | modulus |
| Eb1290- | 1^{st} stage | modulus | (MPa) at | 2^{nd} stage | modulus | (MPa) at |
| TMPTA-PETMP | (° C.) | (MPa) | 38° C. | (° C.) | (MPa) | 38° C. |
| 1.5:1 | 13 ± 2 | 8 ± 1 | 7 ± 1 | 88 ± 4 | 121 ± 20 | 1430 ± 120 |
| 1.2:1 | 29 ± 2 | 24 ± 2 | 27 ± 2 | 49 ± 8 | 50 ± 10 | 460 ± 30 |

TABLE 6
1 wt % IR651 and 0.8 wt % TEA - post cure at 8 mW/cm²

| | | 1^{st} | | | | |
|---|---|---|---|---|---|---|
| | | stage | | | | |
| | | rub- | | | | |
| | T_{g} | bery | 1^{st} stage | T_{g} | 2^{nd} stage | 2^{nd} stage |
| Eb8402- | 1^{st} | mod- | modulus | 2^{nd} | rubbery | modulus |
| TCDDA | stage | ulus | (MPa) at | stage | modulus | (MPa) at |
| PETMP | (° C.) | (MPa) | 38° C. | (° C.) | (MPa) | 38° C. |
| 2:1 | −10 ± | 0.6 ± | 0.6 ± 0.1 | 34 ± 3 | 17 ± 2 | 20 ± 7 |
| | 4 | 0.1 | | | | |

TABLE 7
1 wt % IR651 and 0.8 wt % TEA - post cure at 8 mW/cm²

| | T_{g} | 1^{st} stage | 1^{st} stage | | 2^{nd} stage | 2^{nd} stage |
|---|---|---|---|---|---|---|
| | 1^{st} | rubbery | modulus | T_{g} | rubbery | modulus |
| TCDDA/ | stage | modulus | (MPa) at | 2^{nd} stage | modulus | (MPa) at |
| Ebe1290:PETMP | (° C.) | (MPa) | 38° C. | (° C.) | (MPa) | 38° C. |
| 2:1 | 24 ± 2 | 10 ± 1 | 11 ± 1 | 133 ± 7 | 237 ± 10 | 2050 ± 130 |

TABLE 8
1 wt % IR651 and 0.8 wt % TEA - post cure at 8 mW/cm²

| | | | rubbery | | rubbery | rubbery |
|---|---|---|---|---|---|---|
| | T_{g} | rubbery | Modulus | T_{g} | Modulus | Modulus |
| TMPTA- | 1^{st} stage | Modulus | (MPa) at | 2^{nd} stage | post cure | (MPa) |
| TMPTMP | (° C.) | (MPa) | 38° C. | (° C.) | (MPa) | 38 C |
| 1:1 | 12.0 ± 1.0 | 15.0 ± 1.0 | 15.0 ± 1.0 | 11 ± 1 | 20 ± 8 | 21 ± 8 |
| 3:2 | 9.0 ± 1.0 | 10.0 ± 1.0 | 11.0 ± 1.0 | 26.0 ± 1.0 | 33.0 ± 1.0 | 32.0 ± 1.0 |
| 2:1 | −1.0 ± 1.0 | 4.0 ± 1.0 | 4.0 ± 1.0 | 42.0 ± 1.0 | 43.0 ± 1.0 | 52.0 ± 1.0 |

### Example 3

### FTIR Characterization

FTIR was used to monitor the kinetics of two of the initial systems (PETMP/TMPTA and PETMP/TCDDA) during both stages of the dual-cure reaction. Table 9 summarizes conversions for control and experimental mixtures of each of the initial systems. As expected, thiol conversion was near 100% for all systems both before and after UV curing. Furthermore, acrylate conversion during the first stage of curing appeared to be determined by different stoichiometric ratios, while all acrylate groups showed a significant increase in conversion during second stage curing. These results indicated that all thiol reacted with acrylate during the first stage Michael addition and that any excess acrylate in the system was successfully homopolymerized during the second stage photo curing.

TABLE 9
Thiol and acrylate conversions after Stage 1 and Stage 2 curing.
The PETMP/TCDDA and PETMP/TMPTA samples contained
varying thiol-to-acrylate stoichiometric ratios, with 0.8 wt % TEA
to catalyze the Stage 1 cure and 1 wt % Irgacure 651 for the
Stage 2 cure. A UV Black ray lamp with the power set to 8
mw/cm² was used to initiate the Stage 2 photopolymerization.

| | | Stage 1 | | Stage 2 | |
|---|---|---|---|---|---|
| | Thiol- | Thiol | Acrylate | Thiol | Acrylate |
| | acrylate | Conversion | Conversion | Conversion | Conversion |
| Formulation | ratio | (%) | (%) | (%) | (%) |
| PETMP/ | 1:1 | 96 ± 3 | 98 ± 1 | 96 ± 3 | 99 ± 1 |
| TCDDA | 1:1.5 | 94 ± 3 | 57 ± 1 | 97 ± 1 | 94 ± 1 |
| | 1:2 | 95 ± 1 | 46 ± 2 | 97 ± 2 | 97 ± 2 |
| PETMP/ | 1:1 | 97 ± 2 | 99 ± 1 | 97 ± 2 | 99 ± 1 |
| TMPTA | 1:1.5 | 98 ± 2 | 57 ± 2 | 99 ± 1 | 98 ± 2 |
| | 1:2 | 96 ± 4 | 47 ± 2 | 95 ± 3 | 95 ± 5 |

### Example 4

### DMA Characterization

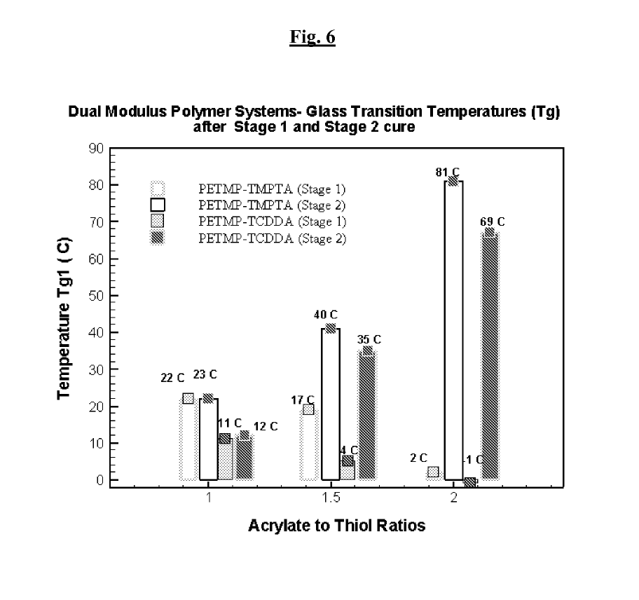

Polymer properties, such as glass transition temperature and modulus, for the polymers prepared herein were characterized using DMA, as illustrated in FIG. 6. All experimental systems showed a significant increase in both T_{g} and modulus during second stage curing, in comparison to little or no response in control systems. FIG. 6 indicates that, as the acrylate-to-thiol ratio increased, T_{g} gradually decreased for the first stage reaction (before UV treatment). This is an indication of the presence of unreacted acrylate groups during the first stage—these unreacted groups are present in-between polymer chains and behave essentially as plasticizers within the system. In this way, the excess acrylate functional groups make the material more flexible and lower the First stage T_{g}. In comparison, the T_{g} of all systems increased during second stage curing as more acrylate chains were introduced into the polymer network. The changes in modulus mirror the results seen in T_{g} in a more dramatic fashion. The response seen during second stage curing was proportional to the amount of acrylate functional groups in excess after the first reaction.

### Example 5

### Modulus Analysis

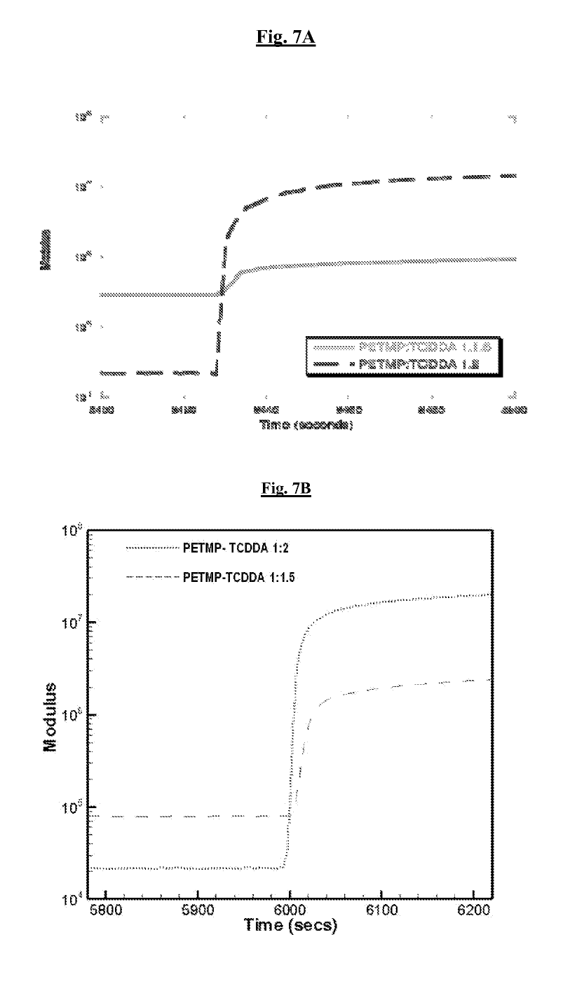

Further modulus analysis was performed on the initial systems using rheology. FIG. 7 illustrates the evolution of modulus compared between 1:1.5 and 1:2 thiol to acrylate systems. The rise in modulus was associated with exposure to UV light, and was notably a more drastic change for the 1:2 ratio. This mixture had initially a much lower modulus than the 1:1.5 mixture and then surpassed this mixture considerably after the second stage of the reaction started. These results were found to be consistent with all other systems (FIG. 7). As the acrylate to thiol ratio increased, the modulus for the first stage polymer decreased, while the modulus for the second stage polymer increased. This is indicative of the presence of unreacted acrylate monomer present in the polymer before UV exposure—after UV exposure, the polymer was strengthened as excess acrylate homopolymerized, creating a highly cross-linked polymer.

### Example 6

### Formulation of a Shape Memory Polymer (SMP) System

To formulate a SMP system, a thiol-acrylate-urethane SMP system was engineered by incorporating a hexafunctional urethane acrylate Ebecryl® 1290 into a monomer mix of PETMP and TCDDA. This system had a first stage T_{g} of 25° C. and a second stage T_{g} of 133° C. However, at 38° C. the system had a modulus of 3,000 MPa. Free strain recovery was also characterized for the SMP system incorporating Ebecryl® 1290 (Table 10).

Free strain recovery is a measure of the ability of the polymer system to recover its permanent shape in the absence of mechanical load as a function of increasing temperature or time. The SMP system showed a free strain recovery of 99%. The shape fixity of a polymer system is an indication of the ability of the polymer network to store a temporary shape at a temperature below its transition region. In terms of application, this measure is an indication of the material's ability to store strain energy within the polymer network before the device is activated. The polymer system consistently showed shape fixity of approximately 99%. The shape recovery sharpness gives an indication of the breadth of the transition within which the polymer system would go from its temporary stored shape to its permanent shape. Larger shape recovery sharpness and a narrow strain recovery transition width indicate a rapid transition of the polymer from its stored shape to its final shape. Other SMP systems have been found to exhibit recovery sharpness values that range from 1.8 to 4.2%/° C. (Mather et al., 2009, Ann. Rev. Mat. Res. 39:445-71). Compared to these polymers, the system formulated here demonstrated a relatively rapid recovery level of 3%/° C. The temperature marked as the onset of free strain recovery of the polymer system indicates that the shape recovery process for the system began at an average temperature of −15° C. The onset of shape recovery at a temperature below ambient temperature indicates that the polymer would have to be constrained at ambient temperature to maintain its ability to go from its temporary shape to its final shape. This information will impact the storage of these shape memory systems, which are designed to activate at body temperature.

TABLE 10
Thermo-mechanical shape memory characterization data for two stage reactive SMP
system

| | | Stage1 | | Stage2 | Stage2 | Free | | Shape |
|---|---|---|---|---|---|---|---|---|
| | | Rubbery | Stage2 | Rubbery | Modulus | Strain | Shape | Recovery |
| | Stage1 T_{g} | Modulus | T_{g} | Modulus | At 38° C. | Recovery | Fixity | Sharpness |
| Formulation | (° C.) | (MPa) | (° C.) | (MPa) | (MPa) | (%) | (%) | (%/C) |
| PETMP/ | 30 ± 3 | 21 ± 1 | 95 ± 8 | 64 ± 8 | 1520 ± 60 | 96 ± 1 | 97 ± 1 | 3 ± 1 |
| TCDDA/ | | | | | | | | |
| Ebecryl | | | | | | | | |
| 1290 | | | | | | | | |

### Example 7

### Formulation of a Lithography/Impression Gel

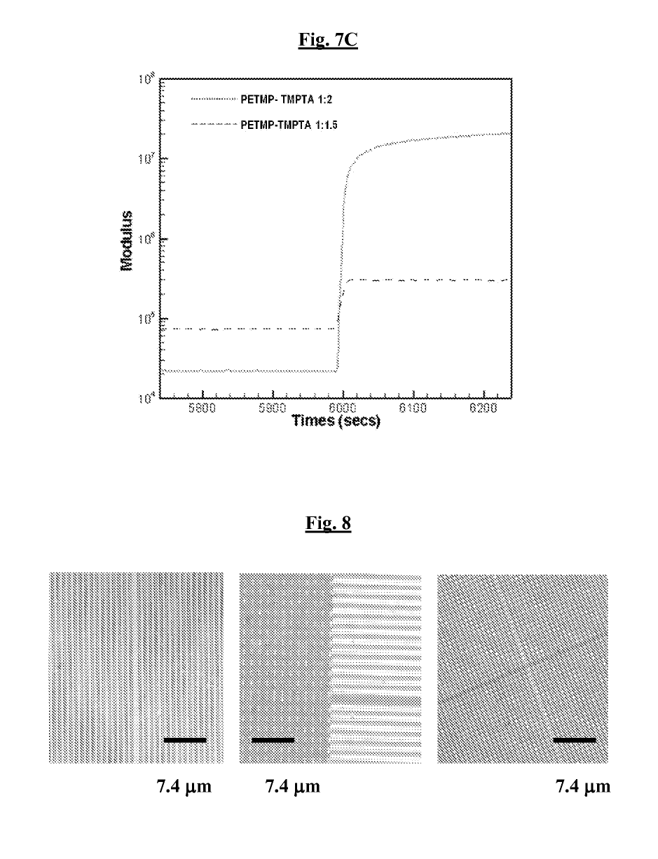

The same thiol-acrylate monomers in differing stoichiometric ratios were used to formulate a polymer system for a lithography/impression gel. In this formulation the thiol-to-acrylate content stoichiometry was 1:14. DMA was used to characterize the gel at the end of the first stage and second stage reactions and is detailed in Table 11. The gel that was formed at the end of first stage was used to take the imprint of a micron-sized pattern mold. Once the gel pad was in place, and pressed against the imprint, it was exposed to UV light for 5 minutes, after which the gel was removed and imaged on DIC (differential interference contrast) microscope. As illustrated in FIG. 8, excellent negatives of the pattern from the mold were obtained.

TABLE 11
DMA characterization of the lithography gel.

| | Stage 1 | Stage 1 | Stage 2 | Stage 2 |
|---|---|---|---|---|
| | T_{g} | Modulus | T_{g} | Modulus |
| Formulation | (° C.) | (MPa) | (° C.) | (MPa) |
| PETMP, | −10 ± 4 | 0.5 ± 0.2 | 195 ± 10 | 200 ± 20 |
| TCDDA, | | | | |
| Ebecryl1290 | | | | |

### Example 8

### Enhanced Two-Stage Reactive Polymer Systems

Two-stage reactive thiol/acrylate systems were formulated and characterized with varying monomers and stoichiometries.

Initially, formulations with 1:1 molar ratio of thiol to acrylate functional groups were prepared (Table 12). Four different urethane acrylates were evaluated along with the tetrathiol PETMP and the di-acrylate TCDDA. The urethane acrylates included di-acrylates with average molecular weights of 5,000 (Ebecryl® 230) and 900-1,000 (Ebecryl® 8402), which resulted in soft flexible networks. The remaining urethane acrylates in the study comprised a hexa-functional aromatic urethane acrylate (Ebecryl® 220) and an aliphatic hexa-functional urethane acrylate (Ebecryl® 1290). Ebecryl® 220 and Ebecryl® 1290 had an average molecular weight of 1,000. All of the formulations in this study contained TCDDA as a viscosity modifier to maintain similar, low viscosities.

The 1:1 stoichiometric formulations of thiol to acrylate were characterized using dynamic mechanical analysis to record the glass transition temperature, T_{g}, and the rubbery modulus. The thermomechanical property results for the 1:1 thiol-acrylate systems represented the maximum achievable T_{g} and modulus at the end of the stage 1 Michael addition reactions for the selected monomers. As illustrated in Table 12, the 1:1 stoichiometric thiol/acrylate formulations exhibited glass transition temperatures that ranged from −33° C. for the PETMP/Ebecryl® 230 system to 41° C. for the PETMP/Ebecryl® 1290 system. All formulations contained 0.8 wt % TEA and rubbery modulus was measured at T_{g}+35° C. As all of the acrylates reacted in the Michael addition reaction, there were no remaining acrylate functional groups to react via the photoinitiated radical polymerization, and thus, no significant change in properties was observed upon irradiation of these samples.

TABLE 12
T_{g} and rubbery modulus for the 1:1 thiol-acrylate systems.

| | Thiol:Acrylate | | Rubbery |
|---|---|---|---|
| Polymer System | Ratio | T_{g} (° C.) | Modulus (MPa) |
| PETMP/TCDDA | 1:1 | 16 ± 2 | 7 ± 1 |
| PETMP/Ebecryl 230 | 1:1 | −33 ± 2 | 0.8 ± 0.2 |
| PETMP/Ebecryl 8402 | 1:1 | −8 ± 2 | 3 ± 2 |
| PETMP/Ebecryl 220 | 1:1 | 33 ± 3 | 18 ± 8 |
| PETMP/Ebecryl 1290 | 1:1 | 41 ± 2 | 25 ± 1 |

Based on the data from Table 12, off-stoichiometric systems were formulated to achieve a range of T_{g} and moduli at the end of the stage 1 and stage 2 polymerizations. Formulations comprising the thiol, PETMP, the diacrylate, TCDDA, and urethane acrylates were formulated, as illustrated in Table 13. These formulations are referred to as F-230 (PETMP/TCDDA/Eb-230), F-8402 (PETMP/TCDDA/Eb-8402), F-220 (PETMP/TCDDA/Eb-220) and F-1290 (PETMP/TCDDA/Eb-1290). The ratios were selected to yield a range of stage 1 and stage 2 properties for the dual-network forming thiol/acrylate systems.

TABLE 13
Thiol/diacrylate/urethane acrylate molar ratios for formulations
evaluated in this work. Formulations with systematic
variation of the acrylate monomer type and the relative
amount of thiol and acrylate functional groups illustrated.

| | Thiol:TCDDA | Thiol:Urethane |
|---|---|---|
| Polymer System | Ratio | Acrylate Ratio |
| F-230 | 1:2.4 | 1:0.4 |
| F-8402 | 1:1.5 | 1:1.5 |
| F-220 | 1:0.5 | 1:2.5 |
| F-1290 | 1:0.5 | 1:1.5 |

Two-stage reactive systems enable a material to have an intermediate processing step, along with the ability to “dial in” a final set of material properties that would optimize the ability of the material to function as a device for a specific application. Formulating materials with a range of stage 1 material properties would considerably enhance the processing capabilities of such dual-cure network forming systems.

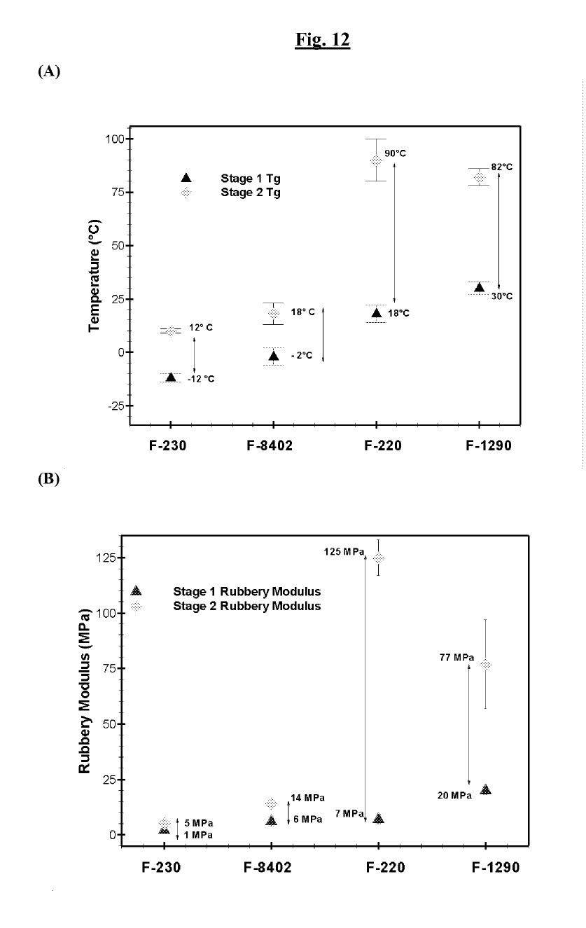

The 1:1 stoichiometry thiol-acrylate formulation for F-230 yielded a T_{g} of 16° C. and a modulus of 7 MPa. The stage 1 F-230 system was found to be soft and flexible at ambient temperature with a modulus of 1 MPa and a T_{g} of −12° C. (FIG. 12). The observed properties were largely due to the excess unreacted acrylic groups within the network. Additionally, as the urethane acrylate Ebecryl® 230 is a high molecular weight diacrylate molecule, the crosslinks formed by this polymer in stage 2 tend to form a highly flexible polymer network. As this formulation went from stage 1 to stage 2, the T_{g} and the modulus went from 1 MPa to 5 MPa (FIG. 12B). However, the material still remained soft and retained considerable flexibility following the second stage curing. F-230 may be ideal for applications that benefit from a polymer that is soft and flexible for the intermediate processing step (thus enabling it to be molded in a particular geometry) but also require considerable retention of elasticity after the final cure, such as vibration dampeners and soft dental lining materials (Park et al., 2009, J. Biomed. Mater. Res. B Appl. Biomater. 91:61; Graham et al., 1991, J. Dent. Res. 70:870).

The 1:1 stoichiometry thiol-acrylate formulation for F-8402 yielded a T_{g} of −8° C. and a modulus of 3 MPa. Ebecryl® 8402 is a urethane diacrylate with a lower molecular weight than Ebecryl® 230. The F-8402 formulation, relative to the F-230 system, had slightly higher modulus at the end of stage 1 at 6 MPa (FIG. 12B). The stage 1 formulation also retained considerable flexibility at ambient conditions, as it had a T_{g} of −2° C. Consequently, the molecular weight between crosslinks in this system should be lower, thereby restricting chain mobility and increasing the system modulus. The stage 1 modulus F-8402 was 6 times the stage 1 modulus of F-230. F-8402 had a modulus of 14 MPa after stage 2, which is more than twice the stage 2 modulus of the F-230 formulation (FIG. 12). The T_{g} of this system also increased from −2 to 18° C., such that the polymer still remained rubbery and flexible at ambient temperature. This higher stage 2 T_{g} would enables F-8402 to function in environments that require a higher modulus polymer than F-230. The stage 1 and stage 2 thermomechanical properties of the F-230 and F-8402 system make them ideal for applications such as dental soft lining materials and bioimplants, which have to function in a mechanically diverse environment (Wang et al., 2002, Nature Biotechnology 20:602; Krongauz & Trifunac, In “Processes in Photoreactive Photopolymers” (Chapman & Hall, New York, 1994)).

The 1:1 stoichiometry thiol-acrylate formulation for F-220 yielded a T_{g} of 33° C. and a modulus of 18 MPa. F-220 contains the low molecular weight, hexafunctional aromatic urethane acrylate Ebecryl® 220. The characteristics of a two-stage reactive system such as the F-220, with a stage 1 T_{g} of 18° C. and modulus of 7 MPa (FIG. 12), would be ideal for applications such as a holographic writing material, which have to be sufficiently rubbery at ambient conditions to allow index patterning and diffusion (Ye & McLeod, 2008, Opt. Lett. 33:2575). In a holographic polymeric storage device, structured illumination is used to initiate polymerization, causing local concentration gradients and diffusion and thus driving changes in density and refractive index. However, once diffusion is complete and the structures formed within the material, there are significant disadvantages with materials that remain soft and flexible, including the fact that the material is now susceptible to environmental contaminants that may diffuse into the network (Ramakrishna et al., 2001, Comp. Sci. Tech. 61:1189). A two-stage reactive system such as F-220 at stage 1 may form a polymer matrix with excess unreacted acrylate functional groups within the network, wherein the unreacted acrylate moieties essentially acts as a plasticizer within the network, enabling chain mobility and thus diffusion. Once diffusion is complete and the holographic structures are formed, the stage 2 photopolymerization forms a highly crosslinked and mechanically robust glassy network.

Indeed, this material showed a stage 2 T_{g} of 90° C. and was highly crosslinked with a rubbery modulus of 125 MPa (FIG. 12). Crosslinking the excess acrylates in stage 2 gave rise to a highly rigid network with a low molecular weight between crosslinks. Although both F-220 and F-8402 had similar stage 1 moduli, there was a 7-fold increase in the stage 2 modulus of F-220 in comparison with F-8402, showing that for the dual-cure polymer formulations stage 2 properties may be largely independent of their stage 1 properties.

Other applications may require a material with stage 2 properties similar to those of F-220 (a high modulus glassy polymer system), but with a more mechanically robust stage 1 polymer network. With that in mind, the F-1290 system, comprising a low-molecular weight, aliphatic urethane hexaacrylate (Ebecryl® 1290), was prepared. The 1:1 stoichiometry of thiol to acrylate formulation for this system yielded a T_{g} of 41° C. and a modulus of 25 MPa. The F-1290 system showed a stage 1 modulus of 20 MPa and a stage 1 T_{g} of 30° C. (FIG. 12). Along with having an intermediate stable processing step at stage 1, it is important to control the crosslinked network formed at stage 2 in order to obtain a specific final mechanical modulus, since in an application such as a biomedical implant device the polymeric device should preferably match the modulus and mechanical properties of the surrounding environment to function effectively as an implant (Ye et al., 2011, Macromol. 44:490). The F-1290 system showed a stage 2 modulus of 77 MPa and T_{g} of 82° C. A biomedical device made from a dual-cure polymer such as F-1290 may have a low stage 1 modulus, aiding the delivery of the device to its location in-vivo with minimal trauma. Once in its target location, one could increase the modulus of the material in-situ so as match its local environment and function optimally. Such devices would be especially useful for applications such as orthopedic devices, where high mechanical strength is often a prerequisite for potential orthopedic materials.

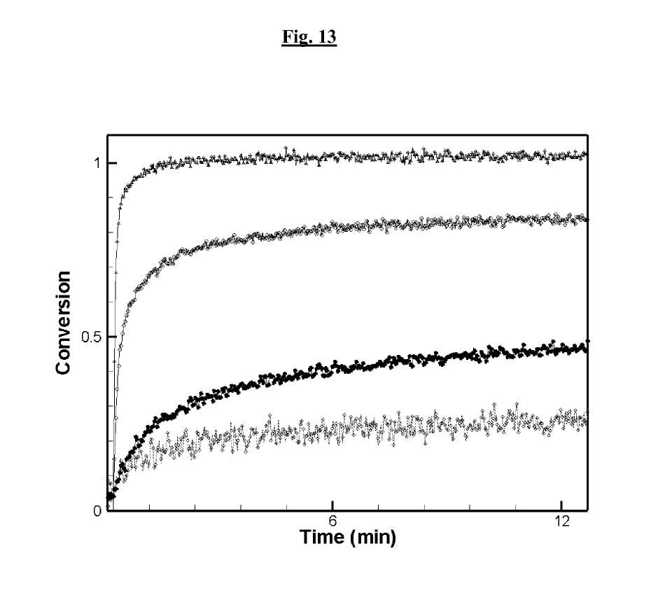

The photoinitiated evolution of the stage 2 network associated with the reaction of the excess acrylate functional groups is illustrated in FIG. 13. The F-230 formulation system exhibited close to 100% conversion of the remaining 28.5% of the unreacted acrylate monomers during stage 2 curing within the first minute of being exposed to the UV light. For the F-8402 close to 80% of the remaining 33% of the acrylate groups were polymerized by the end of Stage 2, comprising 6 minutes of irradiation. The high stage 2 T_{g} systems, F-220 and F-1290, had much lower stage 2 acrylate overall conversions, with 25% of the acrylate reacting for the F-220 system and 40% of the acrylates reacting for the F-1290 system. The reduced conversion observed in the hexaacrylate system may be explained by the severe mobility restriction on the radicals due to vitrification of the polymer matrix. As the polymerization proceeds, the decrease in free volume and the restricted mobility of radicals and their ability to reach the double bonds gives rise to the phenomenon of autodeceleration. The reduced stage 2 conversion post-vitrification was also observed in polymers in which the cure temperature of the systems is far below the T_{g} of the polymer network (Senyurt et al., 2007, Macromol. 40:4901). However, despite the relatively low stage 2 conversions, the urethane hexaacrylate systems exhibited a significant increase in modulus (FIG. 12), with the F-220 system showing an 18-fold increase in modulus and the F-1290 system showing a 4-fold increase in modulus, even with more than 50% of the remaining acrylate moieties remaining unreacted.

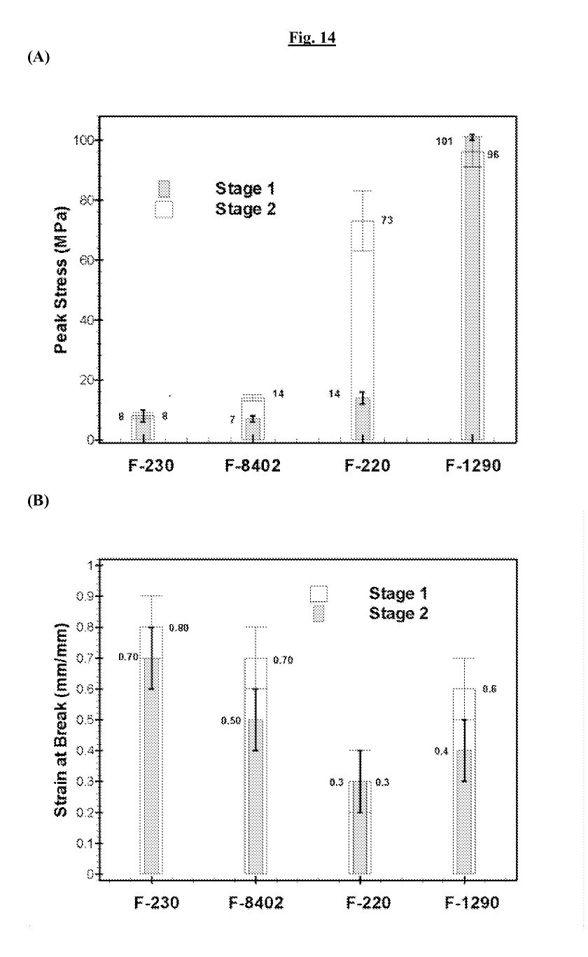

To further characterize the mechanical properties of the polymer networks at the end of stage 1 and stage 2, compression tests were used to measure the peak stress, the strain at break and the toughness of the dual-network forming systems. The presence of the urethane moieties within the polymer network generally enhances the toughness of materials by providing extensive hydrogen bonding in these types of acrylic networks (Senyurt et al., 2007, Macromol. 40:4901). As illustrated in FIG. 14, there were distinct differences in the peak stresses and strain to break at the end of each stage. The F-230 polymer at stage 1 had 80% strain at break, along with a toughness of 3.3 J/m³, and peak stress of 8 MPa. The F-230 formulation did not exhibit a large increase in the peak stress and toughness values between stage 1 and stage 2. However, this system was able to achieve up to 70% strain at break even after stage 2 curing. Given that Ebecryl® 230 is a high molecular weight diacrylate, the high strain capacities at the end of each stage may be attributed to the considerably longer, flexible chains in the polymer network. The presence of the flexible chains extends mobility to the network and dominates the properties of this system. The F-8402, however, showed a 30% reduction in strain at break between stage 1 and stage 2. The stage 2 crosslinking of the polymer matrix also resulted in a 60% increase in toughness and a 2-fold increase in peak stress as it went from stage 1 to stage 2. Although F-230 and F-8402 systems were formulated from urethane diacrylates and had similar stage 1 and stage 2 thermomechanical properties, it is of note that the F-8402 formulation could withstand 75% more stress in compression than the F-230 formulation. The variation in mechanical properties of the two urethane diacrylate systems should have implications on application specific design.

The highly crosslinked F-220 stage 2 polymer system exhibited a dramatic a 12-fold increase in toughness from stage 1. The compression test results for this system correlate with the thermomechanical data, which showed a highly crosslinked high T_{g} polymer network with a rubbery modulus of 125 MPa. However, the strain measures for the F-220 system did not show considerable differences between stage 1 and stage 2 and remained at 30%.

Interestingly, the urethane hexacrylate system, F-1290, had a stage 1 toughness that was 28 times that of F-220 (the mechanical measures at stage 1 determine the type of intermediate processing to which the dual-cure networks may be subject). The F-1290 formulation though showed a reduction in both strain and toughness measures following the second stage curing. Although the peak stress values remained within error close to 100 MPa, a 33% reduction in strain and a 31% reduction in toughness were observed. Even though a reduction in strain is expected after the second curing step due to the increased crosslinking of the hexacrylates within the polymer matrix, a reduction in toughness results from the formation of a more brittle, glassier material.

Overall, all systems showed that the strain at break, peak stress and toughness measures were a function of the amount of crosslinking within the polymer network and the specific nature of the monomers used within the formulations.

The present study showed that, with different monomer types having the same reactive functionality, it is possible to achieve a range of properties following both the initial and final curing steps. Comparison of the F-8402 and F-220 systems demonstrated that it was possible to have distinct formulations with similar stage 1 properties and vastly different stage 2 properties. The F-230 formulation exhibited similar mechanical properties as it went from stage 1 to stage 2, retaining a highly flexible polymer despite increased crosslinking. F-8402, with similar stage 1 properties to F-230, formed a tougher, stronger polymer after the final reactions, whereas the F-220 and F-1290 formulations had varied stage 1 properties, but displayed similar final material properties.

The four formulations thermomechanically and mechanically analyzed in this Example exhibited a range of largely independent properties that may be achieved at each reaction stage in the dual-cure approach. Given the range of distinct stoichiometries and monomer types that may be used to formulate dual-cure networks, this study is representative of the possible systems that can be designed for distinct applications.

### Example 9

### Characterization of Thermomechanical and Mechanical Properties of Two-Stage Polymer Composite System Comprising Material Fillers

As demonstrated herein, a fiber loading of up to 60% volume in a polymer matrix may significantly increase the modulus of the polymer and the strain at break of the composite system, without changing its thermomechanical characteristics such as glass transition temperature (T_{g}) of the fiber reinforced composite system. Thus, the use of composites materials in a two-stage reactive polymer system may have a similar impact on the stage 1 properties of the two-stage reactive polymer system. As described herein, two examples of two-stage reactive polymer matrices were reinforced with differing ratios of PET and Kevlar meshes to form composite laminates. Further, two-stage reactive polymer systems with methacrylated micron size filler particles were formulated and characterized. The systems were mechanically and thermomechanically characterized to determine the stage 1 and stage 2 moduli and glass transition temperatures, along with tensile modulus and strain capacity under ambient conditions. All samples contained 0.05 wt % inhibitor, 0.8 wt % triethyl amine as a catalyst for the first stage reaction and 0.5 wt % I651 to initiate the second stage reaction.

Two examples of two-stage reactive thiol-acrylate systems were prepared as matrices for the polymer composite systems. The thiol-acrylate system (S1) comprised non-stoichiometric ratios of a tetrathiol (PETMP), a diacrylate (TCDDA) and a urethane hexafunctional acrylate (Ebecryl® 1290). Ebecryl® 1290 has a molecular weight of 1000. The second polymer system (S2) comprised PETMP/TCDDA and a long chain, diacrylate Ebecryl® 8402 with a molecular weight of 900. The S1 system comprised thiol and acrylate functional groups in the ratio 1:2, whereas the S2 system comprised a thiol to acrylate functional group ratio of 1:3. As illustrated in FIG. 12A, thermomechanical analysis of both the S1 and S2 two-stage reactive systems showed that the S1 system had stage 1 and stage 2 glass transition temperatures (T_{g}) that were higher than ambient temperature (22° C.) at 30±3° C. and 82±4° C., respectively. The S2 system exhibited stage 1 and stage 2 T_{g}s lower than ambient temperature at −2±4 and 18±5° C., respectively.

The stage 1 polymer network was formed via a triethylamine catalyzed thiol-acrylate click Michael addition reaction. All formulations also contained a UV initiator IR 651 to initiate the acrylic homopolymerization to form the stage 2 network. The S1 formulation had a stage 1 modulus of 20±2 MPa and a stage 2 modulus of 77±20 MPa. The S2 formulation had a stage 1 modulus of 6±2 MPa and a stage 2 modulus of 14±5 MPa (FIG. 12).

The PET mesh and Kevlar veil selected to reinforce the two-stage reactive polymers were mechanically characterized (Table 14). The tensile data shows that the Kevlar veil forms a high modulus, rigid material with a very low strain at break of 0.1 mm/mm. The PET mesh forms a less rigid, high strain material with a modulus of 24 MPa and strain at break of 0.6 mm/mm

TABLE 14
Tensile modulus and strain at break, as measured on dog-bone
shaped Kevlar veil and PET mesh material at ambient temperature.

| Reinforcement Material | Modulus (MPa) | Strain at Break (mm/mm) |
|---|---|---|
| Kevlar Veil | 70 ± 20 | 0.05 ± .04 |
| PET Mesh | 24 ± 2 | 0.6 ± .02 |

Composite systems with differing filler content from the silica particles, the PET mesh and the Kevlar veil were formulated for both the S1 and S2 two-stage reactive polymer systems (Table 15 and 16, respectively; formulation codes reported therein).

TABLE 15
Composite system for S1 formulation along with filler type and content

| Composite | | | Volume |
|---|---|---|---|
| System | Polymer Matrix | Composite Filler | percent |
| S1-10P | S1 | Silica Particles | 10 |
| 52-20P | S1 | Silica Particles | 20 |
| S1-30K | S1 | Kevlar Veil | 30 |
| S2-60K | S1 | Kevlar Veil | 60 |
| S1-30PET | S1 | PET mesh | 30 |
| S2-60PET | Si | PET mesh | 60 |

TABLE 16
Composite system for S2 formulation along with the filler type and content

| Composite | | | Volume |
|---|---|---|---|
| System | Polymer Matrix | Composite Filler | percent |
| S2-10P | S2 | Silica Particles | 10 |
| S2-20P | S2 | Silica Particles | 20 |
| S2-30K | S2 | Kevlar Veil | 30 |
| S2-60K | S2 | Kevlar Veil | 60 |
| S2-30PET | S2 | PET mesh | 30 |
| S2-60PET | S2 | PET mesh | 60 |

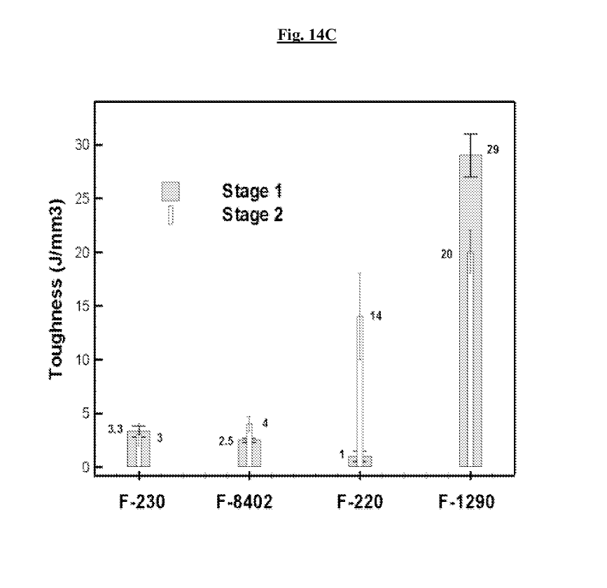

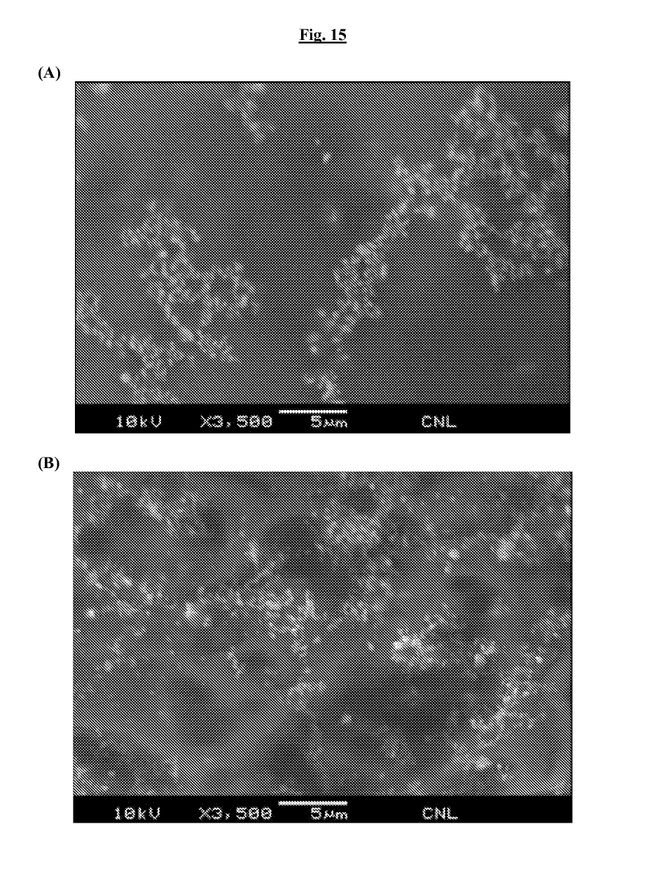

The silica particles were dispersed within the polymer matrix in 10 and 20 volume %. SEM images in FIG. 15 illustrate the silica particles within the S1 matrix at stage 1. SEM images in FIG. 16 illustrate the stage 1 images of the silica composites for S2 system.

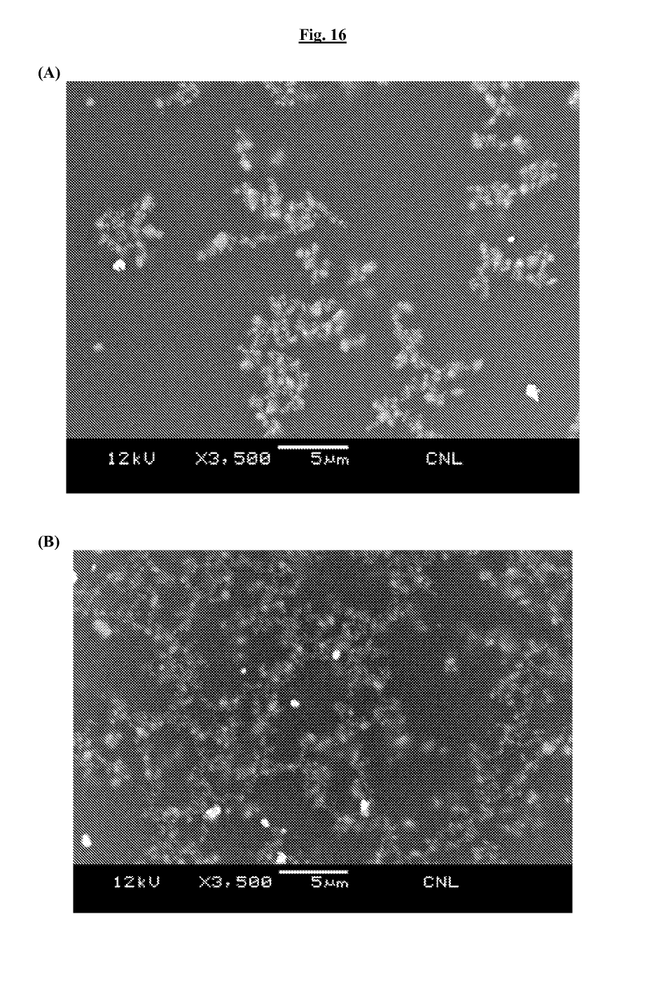

FIG. 17 illustrates the stage 1 thermomechanical data T_{g} of the S1 and S2 systems as composites. The composite systems for both formulations did not show significant variations in the stage 1 T_{g} when compared with the T_{g} of the neat matrix. The S1 formulation had a T_{g} of 30±3° C. and the S2 formulation had a T_{g} of −2±4° C. The lack of significant changes in T_{g} along at stage 1 and stage 2 of both composite systems is usually considered a criterion of compatibility between the neat matrix and the filler material in a polymer composite. The presence of a single tan delta point on the curve also indicates a homogenous polymer system.

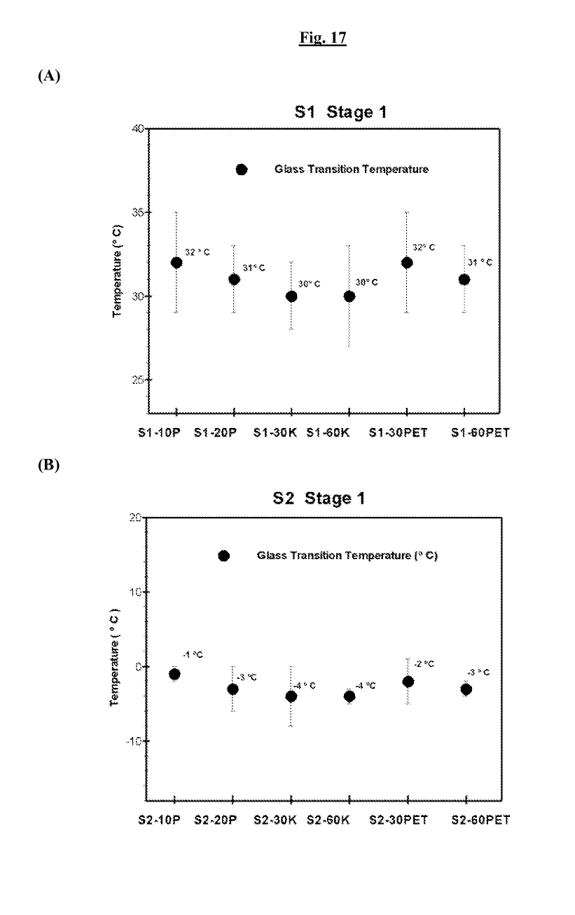

The modulus at stage 1 for the systems, however, showed significant variation. The S1 composite systems achieved an increase in the rubbery modulus in comparison with the neat polymer matrix (FIG. 18). The S1 polymer matrix had a modulus of 20 MPa. The most dramatic change in modulus was observed for the S1-60K and S1-60PET composites, which achieved a 275% and 350% increase in modulus respectively. The increase in modulus observed for the PET and Kevlar S2 polymer composites followed a similar trend as S2 composites, achieving up to a 200% increase in modulus in the 52-60PET system when compared to the neat polymer system. However, overall the increase in modulus seen at stage 1 for the S2 systems was less dramatic in comparison with the S1 composites, with the silica particles failing to impact the rubbery modulus of the S2-silica composites to any significant extent. A possible reason for this result could be that the 1:3 thiol/acrylate non-stoichiometric S2 system has 66% of unreacted acrylates present within the system at stage 1. The unreacted acrylate functional groups essentially function as network plasticizers, lending significant chain mobility within the polymer network. Also, as Ebecryl® 8402 is a high molecular weight, long chain difunctional molecule that allows considerable mobility of chains between the tethering crosslinks within the network, the untethered silica particles fail to add significantly to the modulus of the network in stage 1. Thus, the S2-10P and S2-20P composites with 10 and 20 volume % of silica particles as reinforcements within such a network would fail to add significant reinforcement to the composite at stage 1. At stage 1, the modulus of the S1 and S2 composite systems were dominated by the type and concentration of the composite filler in the systems.

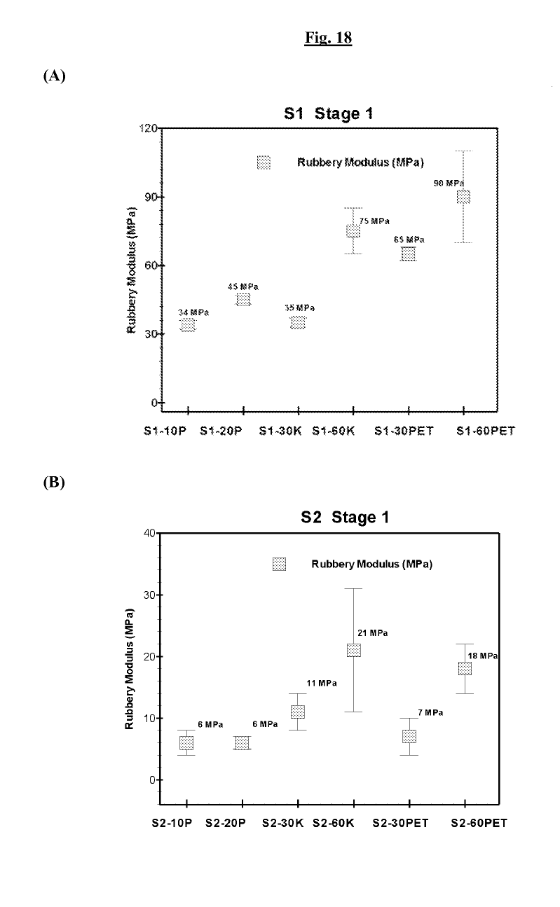

The stage 2 glass transition temperature of both the S1 and S2 composites are illustrated in FIG. 19. There was no significant change in the stage 2 T_{g} when compared with the stage 2 T_{g} of the neat polymer matrix at 82° C. The slight drop in T_{g} seen in the S1 silica composites S1-20P and S1-10P at 10% and 6% was within experimental error. Similarly, the S2 composites also demonstrated no significant change in the stage 2 T_{g} of the composite system when compared with the T_{g} of the neat matrix at 18° C. The T_{g} of the composite systems at stage 2 remained consistent with that of the neat polymer matrices.

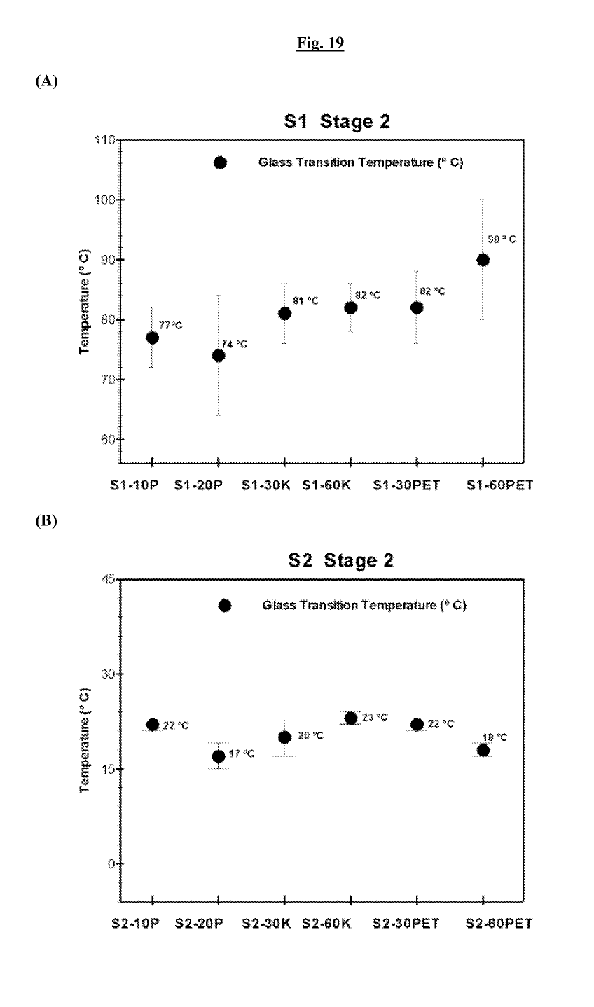

The modulus at stage 2 for the S1 composites showed significant increase when compared to that of the neat polymer matrix (FIG. 20). The PET composites considerably enhanced the stage 2 modulus of the S1 systems with the S1-60PET mesh composite system achieving a 79% increase in modulus. The S1-30PET composite, along with the Kevlar S1-30K composites and the S1-10P composite, achieved a modest increase in the average modulus between stage 1 and stage 2 of up to 29%. However, the S1-20 P composite achieved over a two-fold increase in modulus at 155 MPa. This dramatic increase in modulus could be attributed to the methacrylated silica particles crosslinking with the polymer matrix at stage 2. The S1-60K Kevlar composite also exhibited a significant 2-fold increase in stage 2 modulus. The results show that, for the S1 composites system, the volume of filler played a significant part in the modulus at stage 2. The S2 composites, the S2-60K Kevlar composite and the 52-60PET composite showed an increase in modulus by 250% and 200% respectively, when compared to the stage 1 modulus. In stage 2, the S2-60K, S2-30K Kevlar and PET mesh composites increased the modulus by similar values, with the Kevlar veil composites showing a 143% increase in modulus, and the PET composite achieving a 120% increase in modulus. The methacrylated silica particles that crosslink into the polymer matrix in stage 2 significantly increased the modulus by up to 100% as illustrated by the S2-60P silica composite.

Overall, the composites filler for both the S1 and S2 systems failed to significantly impact the T_{g} at both stage 1 and stage 2. The modulus, however, at stage 1 was impacted by the filler type and content for both the S1 and S2 composites. For the S1 composites, the stage 2 modulus was markedly impacted by the filler concentration. There was an increase in modulus by the filler only if the filler was present in significant quantities, as seen in the S1-20P, S1-60K and S1-60PET composites. Otherwise, the matrix dominated the stage 2 modulus measure for this system. For the S2 system however, the modulus at stage 2 continued to be dominated by both the filler type and concentration.

The tensile strength, strain at break and toughness of the polymer networks was characterized and the data is presented in Tables 17-20. Based on the peak stress and the strain at break of these systems, the toughness of the network at the end of each stage was calculated. Table 17 illustrates the tensile modulus data and the strain at break for the S1 composite systems and the data for the neat polymer matrix. The stage 1 silica composite systems of both S1-20P and S1-10P showed a slight decrease in tensile strength, consistent with particle filler composites in which the particles are not tethered to the network. The Kevlar veil composites showed an average 49% increase in tensile strength, whereas the PET mesh composites showed a dramatic 272% increase on average. The tensile modulus for stage 2 of the composites systems were largely dominated by the tensile properties of the polymer matrix and did not show a significant variation when compared with the neat matrix. The strain at break of silica composite systems and the PET mesh composite systems at stage 1 increased by 54% and 85% respectively, when compared to the neat polymer matrix. The Kevlar composites showed no appreciable increase in strain at break at stage 1 when compared with the neat matrix.

In comparing the composites between stage 1 and stage 2, all composites showed a reduction in strain at break along with an increase in the tensile modulus as expected due to the significant crosslinking at stage 2. However, on average the increase in tensile modulus of the composites when compared to the neat matrix was less in stage 2 in comparison with stage 1. While the composite filler type and quantity controlled the tensile modulus in stage 1, the stage 2 modulus was largely controlled by the polymer matrix properties at ambient temperature and therefore the filler type and content had less impact on the stage 2 composites.

TABLE 17
Stage 1 and the stage 2 tensile modulus and strain at break of the S2
composite system measured at ambient temperature (22° C.)

| | Stage 1 | Stage 1 | Stage 1 | Stage 2 |
|---|---|---|---|---|
| | Tensile | Strain at | Tensile | Strain at |
| Polymer | Modulus | Break | Modulus | Break |
| System | (MPa) | (mm/mm) | (GPa) | (mm/mm) |
| S1 | 43 ± 5 | 0.13 ± 0.01 | 1.6 ± 0.2 | 0.03 ± 0.001 |
| S1-10P | 38 ± 4 | 0.2 ± 0.01 | 1.7 ± 0.1 | 0.02 ± 0.004 |
| S1-20P | 31 ± 2 | 0.2 ± 0.05 | 1.8 ± 0.1 | 0.02 ± 0.01 |
| S1-30K | 75 ± 20 | 0.1 ± 0.04 | 1.5 ± 0.2 | 0.03 ± 0.01 |
| S1-60K | 53 ± 10 | 0.12 ± 0.02 | 1.5 ± 0.2 | 0.02 ± 0.003 |
| S1-30PET | 140 ± 30 | 0.23 ± 0.05 | 1.2 ± 0.2 | 0.05 ± 0.02 |
| S1-60PET | 180 ± 30 | 0.27 ± 0.02 | 1.7 ± 0.6 | 0.03 ± 0.01 |

Table 18 illustrates the modulus and strain at break values for the S2 polymer system. The strain at break of the composites between stage 1 and stage 2 followed the same trend as the S1 systems, with the Kevlar composites alone showing no significant increase in strain in stage 1. However, the tensile modulus increased significantly across all composites in stage 1 with the S2-60K Kevlar composite and S2-60PET mesh composite showing a 12-fold increase and 4-fold increase in modulus respectively. In stage 2, all composite systems showed an increase in modulus when compared with the neat polymer matrix, with the 52-20P composite showing a 3.7 fold increase in tensile modulus. The S2-60K composite and the 52-60PET mesh composite showed a 3.5-fold increase and a 2.7-fold increase in tensile modulus values. Unlike the S1 system in which the stage 2 tensile modulus was largely controlled by the matrix properties, the stage 2 modulus values of the S2 composite systems may be attributed to filler properties within the polymer matrix. As the S2 system has a T_{g} of 18° C. at stage 2, S2 composites may retain sufficient mobility at ambient conditions compared to the S1, and therefore the composite filler type may be able to have a greater impact the properties at stage 2.

TABLE 18
Stage 1 and the stage 2 tensile modulus and strain at break of the S2
system measured at ambient temperature (22° C.)

| | Stage 1 | Stage 1 | Stage 2 | Stage 2 |
|---|---|---|---|---|
| | Tensile | Strain at | Tensile | Strain at |
| | Modulus | Break | Modulus | Break |
| Polymer System | (MPa) | (mm/mm) | (MPa) | (mm/mm) |
| S2 | 5 ± 2 | 0.16 ± 0.05 | 13 ± 8 | 0.13 ± 0.1 |
| S2-10P | 7 ± 0.3 | 0.2 ± 0.05 | 21 ± 1 | 0.10 ± .01 |
| S2-20P | 4 ± 1 | 0.3 ± 0.05 | 48 ± 5 | 0.13 ± 0.02 |
| S2-30K | 23 ± 6 | 0.1 ± 0.03 | 45 ± 10 | 0.05 ± 0.02 |
| S2-60K | 63 ± 8 | 0.1 ± 0.01 | 60 ± 20 | 0.1 ± 0.06 |
| S2-30PET | 7.4 ± 1 | 0.4 ± 0.2 | 17 ± 5 | 0.2 ± 0.01 |
| S2-60PET | 19 ± 10 | 0.3 ± 0.08 | 35 ± 10 | 0.2 ± 0.1 |

The calculated toughness for the S1 composite system at stage 1 and stage 2 is shown in Table 19. The toughness of composite system depends on both the peak stress values a polymer can attain and the strain at which point the system breaks. There was a 133% increase toughness observed as the system went from stage 1 to stage 2 for the neat polymer matrix, implying that the reduced strain at break is offset by the increase in peak stresses that the system can endure. However, the silica particle and PET mesh composite systems tended to cause a slight reduction in toughness as the systems went from stage 1 to stage 2. This reduction was dominated by reduced strain at break values at stage 2, implying that the stage 2 polymer composites are also relatively brittle compared to stage 1. The Kevlar composites showed an increase in toughness>100% as they went from stage 1 to stage 2, showing that the peak stress attainable by the Kevlar composites in stage 2 is considerably higher than stage 1, even though there was slight reduction in strain observed.

TABLE 19
Stage 1 and the stage 2 calculated toughness values from the peak stress
and strain at break measures of the S1 system at ambient conditions

| | Stage 1 | Stage 2 |
|---|---|---|
| | Toughness | Toughness |
| Polymer System | (J/m³) | (J/m³) |
| S1 | 0.3 ± 0.1 | 0.7 ± 0.1 |
| S1-10P | 0.4 ± 0.1 | 0.4 ± 0.08 |
| S1-20P | 0.32 ± 0.2 | 0.24 ± 0.1 |
| S1-30K | 0.27 ± 0.02 | 0.5 ± 0.2 |
| S1-60K | 0.24 ± 0.1 | 0.5 ± 0.1 |
| S1-30PET | 1.4 ± 0.3 | 0.5 ± 0.1 |
| S1-60PET | 0.6 ± 0.2 | 0.4 ± 0.2 |

The trend observed for S2 toughness measures between stage 1 and stage 2 showed that there was an increase in toughness as the material went from stage 1 to stage 2. The higher chain mobility of the stage 2 polymer in this system along with its T_{g} being close to ambient at stage 2 ensured that the composite systems were less brittle when compared with the stage 1 polymer systems, while enabling them to attain higher peak stress at the end of both stage 1 and stage 2. The increase in toughness for the S2-60 PET mesh system was 9-fold higher when compared with the neat matrix.

Although the S1 composites, with a T_{g} at 30° C., were dominated by the filler type and quantity in stage 1 under ambient conditions, the matrix properties dominated the stage 2 properties for this system, which is glassy at ambient temperature with a stage 2 Tg of 82° C. For the S2 system, with both stage 1 and stage 2 T_{g}'s below ambient temperature at −2 and 18° C. respectively, the filler type and content influenced both the stage 1 and stage 2 properties of the composites in both stage 1 and stage 2.

TABLE 20
Stage 1 and the stage 2 calculated toughness values from the peak stress
and strain at break measures of the S2 system at ambient conditions

| | Stage 1 | Stage 2 |
|---|---|---|
| | Toughness | Toughness |
| Polymer System | (J/m³) | (J/m³) |
| S2 | 0.1 ± 0.07 | 0.3 ± 0.1 |
| S2-10P | 0.1 ± .02 | 0.1 ± .01 |
| S2-20P | 0.12 ± 0.02 | 0.4 ± 0.07 |
| S2-30K | 0.08 ± 0.01 | 0.1 ± 0.01 |
| S2-60K | 0.04 ± .01 | 0.3 ± 0.1 |
| S2-30PET | 0.6 ± 0.4 | 0.6 ± 0.4 |
| S2-60PET | 0.5 ± 0.1 | 2.8 ± 1 |

In summary, the fillers used herein were 0.7 μm methacrylated silica particles, translucent Kevlar veil and PET mesh. A thermomechanical and mechanical analysis of two-stage reactive polymer composite systems showed the ability to vary both the stage 1 and stage 2 properties of the S1 and S2 polymer composite systems, without a significant change in the glass transition temperatures (T_{g}). The two-stage matrix composite formed with a hexafunctional acrylate matrix and 20 volume % silica particles showed a 125% increase in stage 1 modulus and 101% increase in stage 2 modulus, when compared with the modulus of the neat matrix. For a composite system with a stage 1 and stage 2 T_{g} s above ambient, the tensile modulus measurements at ambient conditions showed that filler concentration and type dominated the stage 1 modulus, whereas the matrix properties dominated the stage 2 tensile properties.

For the S1 composite systems, considerable increase in modulus at stage 1 and stage 2 was achieved by varying the filler type and content. Such approach allowed one to achieve a range of moduli varying from 85 MPa to 155 MPa, although the polymer matrix dominated the mechanical properties at stage 2. For a low T_{g}, low modulus system such as S2, the filler type and content dominated the mechanical properties of the system at both stage 1 and stage 2. The S2-20P composite demonstrated the ability of having a stage 1 system without alteration in modulus in comparison with the neat polymer matrix, but with a 367% increase in modulus at stage 2. Therefore, the two-stage reactive composite platform may be formulated and tailored to meet a range of material processing requirements, along with end application-specific mechanical and thermomechanical properties.

### Example 10

### Two-Stage Reactive Polymer Networks as Suture Anchor Systems

Two-stage reactive polymeric devices were formulated and mechanically characterized as orthopedic suture anchors for arthroscopic surgery in this study. The devices were aimed at enabling arthroscopic delivery of the anchor devices as implants, while maintaining the ability of the systems to tune in a modulus at a later stage to match the local bone environment.

In a two-stage reactive polymer system formulated herein, the stage 1 devices to be delivered arthroscopically were soft and flexible, with glass transition temperatures (T_{g}) of 30° C. and a modulus at 90° C. at body temperature (38° C.) (Table 21). The neat polymer matrix in the systems tested herein was an off stoichiometric tetrathiol/diacrylate/hexafunctional urethane acrylate system with PETMP, TCDDA and Ebecryl® 1290. This formulation had a thiol to acrylate ratio of 1 to 3. The two-stage reactive polymer composite systems contained different reinforcing materials: PET mesh, Kevlar veil, Kevlar mesh and micron-size silica particles. The composites are referred to as F-60-PET (60 volume % PET mesh), F-60-KV (60 volume % Kevlar Veil), F-20P (20 volume % silica particles) and F-60-KM (60 volume % Kevlar Mesh).

The composites illustrated herein are representative of the range of fillers that may be varied to achieve different moduli at stage 2 at 38° C. while keeping the matrix constant. The stage 1 polymer network has an advantage over metal suture anchor device, because an inherent lack of flexibility of the metals restricts easy repositioning or realigning of the device during delivery and insertion. Also, once a metal suture anchor has been inserted, the difference in modulus may create large defects, leading to device migration. Alternatively, plastic suture anchors may be subject to brittle fracture.

TABLE 21
Stage 1 and stage 2 T_{g} and moduli at 38° C. of the two-stage reactive
composites. T_{g} was measured at the peak of the tan delta curve.

| | | | | Modulus |
|---|---|---|---|---|
| | | Modulus | | (GPa) |
| Polymer | Stage 1-DMA | (GPa) @ | Stage 2-DMA | @ |
| System | Tg (° C.) | 38° C. | Tg (° C.) | 38° C. |
| F-60-PET | 32 ± 3 | 0.09 ± .03 | 82 ± 6 | 2 ± 0.3 |
| F-60-KV | 30 ± 3 | 0.09 ± .01 | 82 ± 4 | 1.2 ± 0.5 |
| F-20-SP | 31 ± 2 | 0.07 ± .02 | 64 ± 10 | 2.3 ± 0.7 |
| F-60-KM | 28 ± 2 | 0.09 ± .02 | 53 ± 5 | 1.3 ± 0.3 |

The stage 2 reaction of the two-stage reactive systems may be implemented in-situon-command, once the device has been placed optimally. The second stage reaction may tailor the modulus of the polymer to match the local bone strength. Table 21 is illustrative of the distinct stage 2 moduli that may be achieved based on a judicious selection of fillers for a particular two-stage reactive polymer system, wherein the initial stage 1 properties are rather similar among the systems. By a judicious choice of monomers and stoichiometries, a wide variety of polymer properties may be achieved at both stage 1 and stage 2.

Studies have also shown a correlation between pullout strength and Bone Mineral Density (BMD). The force required to pull the suture anchor device from the bone is termed the “pullout strength” and is often used to compare the performance of different suture anchors. The pull-out strength of suture anchors from human trabecular bone is between 100 to 200 N (Mimar et al., 2009, Brit. Elb. Shol. Soc. 1:31). In a modified suture anchor pull-out test, the F-60-PET polymer system, shaped as a dog-bone, was tested at the end of stage 1 and stage 2. The stage 1 system with peak load and tensile modulus of 55 MPa and 16 N was found to be a low modulus, high strain, flexible system, with a strain at break at 0.3. This would make it suitable to be delivered in minimally invasive manner. Stage 2 properties of this system, however, had a peak load of 138 N, along with a high modulus of 640 MPa. These values are very favorably comparable to the peak load measures shown by currently marketed suture anchor systems. One should bear in mind that the suture anchor pull-out tests for these includes a suture anchor device embedded within bone at one end and tensile grip on the suture at the other end. One should also bear in mind that the yield strengths of bone and steel differ by orders of magnitude: even though the steel casing used in the pull-out test in this study could have precipitated early device failure, the material still failed at 138 N.

TABLE 22
Stage 1 and stage 2 suture device pull-out test data
for tensile modulus, strain at break and peak load
for the F-60-PET system, recorded at ambient temperature

| | Stage 1 | | | | | |
|---|---|---|---|---|---|---|
| | | Strain | | | | |
| | | at | | Stage 2 | | |
| | | Break | Peak | | Strain at | |
| Polymer | Modulus | (mm/ | Load | Modulus | Break | Peak |
| System | (MPa) | mm) | (N) | (MPa) | (mm/mm) | Load (N) |
| F-60- | 55 ± 1 | 0.3 ± | 16 ± 2 | 640 ± 50 | 0.06 ± | 138 ± 20 |
| PET | | .01 | | | 0.01 | |

The results disclosed herein have shown that distinct stage 1 and stage 2 moduli are achievable for two-stage reactive suture anchor devices. Polymer implant systems may be generated with similar stage 1 properties and tunable stage 2 properties, as to match the orthopedic moduli in the bone environment. In one embodiment, a series of two-stage reactive polymer systems with similar stage 1 glass transition temperatures of 30° C. and modulus of 90 MPa were formulated to achieve varying stage 2 modulus up to 2.3 GPa. Additionally, the pull-out strength of the F-60-PET system was tested and yielded a measure of 138 N, which compared favorably with current high-strength suture anchor systems. In keeping the polymer network constant and varying the composite filler type, this study is representative of the range of properties that may be achieved in a two-stage reactive polymer system for an orthopedic suture anchor. However, it is by no means exhaustive in terms of the wide range of properties that can be achieved via the two-stage reactive composite polymer platform.

### Example 11

### Optical Materials

A dual-cure system formulation for optical systems is described herein, wherein the formulation comprised an initial 6.5:1 ratio of acrylate to thiol functional groups. The system contained PETMP, TCDDA and Ebecryl® 1290 along with 5 wt % of a high refractive index monomer 2,4,6-tribromophenyl acrylate. The theoretical gel point conversion of the base system was calculated to be 0.58 from the Flory-Stockmayer equation. The high refractive index monomer was incorporated to facilitate the formation of areas with a refractive index higher than the base system, thereby generating refractive index patterns that mirror the stage 2 light exposure pattern. The dual-cure material system at the end of Stage 1 was exposed to a holographic writing set-up using a 365 nm argon laser. The collimated laser beam was split into two beams and redirected to interfere in the recording material with a spatial period of 2 μm. Following the Stage 1 curing, two sequential exposures of the material were implemented in Stage 2, the first being a patterned exposure to create the refractive index pattern and the second being a uniform (i.e., flood) curing to react the polymer fully. The flood cure step was initiated by exposing the material to UV light at 8 mW/cm² for 5 minutes. Differential interference contrast (DIC) phase images of the recorded grating were obtained and the pitch of the grating was measured at 2 μm, which matched with the holographic writing set-up.

TABLE 23
Thermomechanical characterization of the two stage
holographic polymer material

| | | Stage 1 | | Stage 2 |
|---|---|---|---|---|
| | Stage 1 | Rubbery | Stage 2 | Rubbery |
| | T_{g} | Modulus | T_{g} | Modulus |
| Formulation | (° C.) | (MPa) | (° C.) | (MPa) |
| PETMP/TCDDA/Ebecryl1290 | 30 ± 4 | 6 ± 1 | 90 ± 10 | 45 ± 4 |

The disclosures of each and every patent, patent application, and publication cited herein are hereby incorporated herein by reference in their entirety.

While the invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of generating a given polymer, comprising the steps of:
providing an initial composition comprising a first polymerizable composition and a second polymerizable composition,
wherein said first polymerizable composition undergoes polymerization when submitted to a first polymerization reaction condition,
wherein said second polymerizable composition undergoes polymerization when submitted to a second polymerization reaction condition, and
wherein said first and second polymerization reaction conditions are orthogonal to each other;
submitting said initial composition to said first polymerization reaction condition to promote polymerization of said first polymerizable composition, thereby forming an intermediate composition; and,
submitting said intermediate composition to said second polymerization reaction condition to promote polymerization of said second polymerizable composition, thereby forming said given polymer.

2. The method of claim 1, wherein said given polymer is used to prepare at least one material selected from the group consisting of a shape memory polymer, optical material, impression material, and combinations thereof.

3. The method of claim 1, wherein said initial composition comprises
a polymerization photoinitiator, at least one acrylate monomer, and a component selected from the group consisting of:
(a) at least one thiol monomer,
wherein the ratio of the thiol equivalent concentration of said at least one thiol monomer in said initial composition and the acrylate equivalent concentration of said at least one acrylate monomer in said initial composition ranges from about 0.05 to about 0.95; and,
(b) a mixture of at least one nucleophile monomer and at least one isocyanate monomer,
wherein the ratio of the nucleophile equivalent concentration of said at least one nucleophilic monomer in said initial composition and the isocyanate equivalent concentration of said at least one isocyanate monomer in said initial composition is about 1:1; and,
wherein said at least one nucleophile monomer comprises a thiol monomer or alcohol monomer;
wherein said initial composition is shaped into a given shape;
wherein said first polymerization reaction condition promotes a reaction selected from the group consisting of:
(a) a reaction between said at least one acrylate monomer and said at least one thiol monomer, and,
(b) a reaction between said at least one nucleophile monomer and said at least one isocyanate monomer;
wherein said intermediate composition comprises unreacted acrylate monomer;
wherein said second polymerization reaction condition promotes photopolymerization of said unreacted acrylate monomer; and,
wherein said given polymer has enhanced mechanical properties over said intermediate composition.

4. The method of claim 3, wherein said initial composition further comprises a compound selected from the group consisting of an accelerator, urethane based acrylate, and combinations thereof.

5. The method of claim 3, wherein said at least one thiol monomer is selected from the group consisting of 2,5-dimercaptomethyl-1,4-dithiane, 2,3-dimercapto-1-propanol, 2-mercapto-ethylsulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, isophorone diurethane thiol, and combinations thereof.

6. The method of claim 3, wherein said at least one acrylate monomer is selected from the group consisting of ethylene glycoldi(meth)acrylate, tetraethyleneglycol-di(meth)acrylate, poly(ethylene glycol)dimethacrylates, the condensation product of bisphenol A and glycidyl methacrylate, 2,2′-bis[4-(3-methacryloxy-2-hydroxypropoxy)-phenyl]propane, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl(meth)acrylate trimethylolpropane triacrylate, tricyclodecane dimethanol diacrylate, and combinations thereof.

7. The method of claim 3, wherein said polymerization photoinitiator is selected from the group consisting of 2,2-dimethoxy-1,2-diphenylethan-1-one, bis(2,4,6-trimethylbenzoyl)-phenylphosphineoxide, 1-hydroxycyclohexyl benzophenone, trimethyl-benzoyl-diphenyl-phosphine-oxide, and combinations thereof; and said photopolymerization is promoted by UV radiation.

8. The method of claim 1, wherein said given polymer is used to prepare an optical device;
wherein said initial composition comprises a polymerization photoinitiator, at least one acrylate monomer, and a component selected from the group consisting of:
(a) at least one thiol monomer,
wherein the ratio of the thiol equivalent concentration of said at least one thiol monomer in said initial composition and the acrylate equivalent concentration of said at least one acrylate monomer in said initial composition ranges from about 0.05 to about 0.95; and,
(b) a mixture of at least one nucleophile monomer and at least one isocyanate monomer,
wherein the ratio of the nucleophile equivalent concentration of said at least one nucleophilic monomer in said initial composition and the isocyanate equivalent concentration of said at least one isocyanate monomer in said initial composition is about 1:1; and,
wherein said at least one nucleophile monomer comprises a thiol monomer or alcohol monomer;
wherein said initial composition is shaped into a given shape;
wherein said first polymerization reaction condition promotes a reaction selected from the group consisting of:
(a) a reaction between said at least one acrylate monomer and said at least one thiol monomer, and,
(b) a reaction between said at least one nucleophile monomer and said at least one isocyanate monomer;
wherein said intermediate composition comprises unreacted acrylate monomer;
wherein refractive index gradients are written into said intermediate composition; and,
wherein said second polymerization reaction condition promotes photopolymerization of said unreacted acrylate monomer, thereby forming said optical device.

9. The method of claim 8, wherein said initial composition further comprises an accelerator, urethane based acrylate, or a combination thereof.

10. The method of claim 8, wherein said initial composition further comprises at least one high-refractive index acrylate.

11. The method of claim 10, wherein said at least one high-refractive index acrylate comprises 2,4,6-tribromophenyl acrylate.

12. The method of claim 1, wherein said given polymer is used to prepare a polymer pad with a given imprint;
wherein said initial composition comprises a polymerization photoinitiator, at least one acrylate monomer, and a component selected from the group consisting of:
(a) at least one thiol monomer,
wherein the ratio of the thiol equivalent concentration of said at least one thiol monomer in said initial composition and the acrylate equivalent concentration of said at least one acrylate monomer in said initial composition ranges from about 0.05 to about 0.95; and,
(b) a mixture of at least one nucleophile monomer and at least one isocyanate monomer,
wherein the ratio of the nucleophile equivalent concentration of said at least one nucleophilic monomer in said initial composition and the isocyanate equivalent concentration of said at least one isocyanate monomer in said initial composition is about 1:1; and,
wherein said at least one nucleophile monomer comprises a thiol monomer or alcohol monomer;
wherein said initial composition is shaped into a given shape;
wherein said first polymerization reaction condition promotes a reaction selected from the group consisting of:
(a) a reaction between said at least one acrylate monomer and said at least one thiol monomer, and,
(b) a reaction between said at least one nucleophile monomer and said at least one isocyanate monomer;
wherein said intermediate composition comprises unreacted acrylate monomer;
wherein said intermediate composition is pressed into a master pattern block,
wherein said block comprises the negative image of said given imprint; and,
wherein said second polymerization reaction condition promotes photopolymerization of said unreacted acrylate monomer, thereby forming said given imprint on said polymer pad.

13. The method of claim 12, wherein said initial composition further comprises at least one compound selected from the group consisting of an accelerator and a polymerization photoinitiator.

14. (canceled)

15. A composition comprising at least one component selected from the group consisting of:
(a) an acrylate monomer and at least one thiol monomer,
wherein the ratio of the thiol equivalent concentration of said at least one thiol monomer in said composition and the acrylate equivalent concentration of said at least one acrylate monomer in said composition ranges from about 0.05 to about 0.95;
(b) a mixture of at least one nucleophile monomer and at least one electrophile monomer,
wherein the ratio of the nucleophile equivalent concentration of said at least one nucleophile monomer in said composition and the electrophile equivalent concentration of said at least one electrophile monomer in said composition ranges from about 2:1 to about 1:2;
wherein said at least one electrophile monomer comprises an isocyanate monomer or epoxy monomer; and,
wherein said at least one nucleophile monomer comprises a thiol monomer or alcohol monomer;
(c) at least one thiol monomer and at least one monomer selected from the group consisting of acrylate, methacrylate, acrylamide, methacrylamide, maleimide, acrylonitrile, cyanoacrylate and combinations thereof, further optionally comprising a phosphine;
and,
(d) at least one thiol monomer, at least one acrylate monomer, and at least one ene monomer,
wherein the ratio of said at least one thiol monomer to said at least one acrylate monomer is greater than about 1:1.

16. The composition of claim 15, wherein said at least one thiol monomer is selected from the group consisting of 2,5-dimercaptomethyl-1,4-dithiane, 2,3-dimercapto-1-propanol, 2-mercapto-ethylsulfide, 2,3-(dimercaptoethylthio)-1-mercaptopropane, 1,2,3-trimercaptopropane, ethylene glycol bis(thioglycolate), ethylene glycol bis(3-mercaptopropionate), pentaerythritol tetra(3-mercaptopropionate), trimethylolpropane tris(3-mercaptopropionate), pentaerythritol tetra(2-mercaptoacetate), trimethylolpropane tris(2-mercaptoacetate), 1,6-hexanedithiol, 1,2-benzenedithiol, 1,3-benzenedithiol, isophorone diurethane thiol, and combinations thereof.

17. The composition of claim 15, wherein said at least one acrylate monomer is selected from the group consisting of ethylene glycol di(meth)acrylate, tetraethyleneglycol-di(meth)acrylate, poly(ethylene glycol)dimethacrylates, the condensation product of bisphenol A and glycidyl methacrylate, 2,2′-bis[4-(3-methacryloxy-2-hydroxypropoxy)-phenyl]propane, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl(meth)acrylate trimethylolpropane triacrylate, tricyclodecane dimethanol diacrylate, and combinations thereof.

18. The composition of claim 15, further comprising at least one compound selected from the group consisting of an accelerator and a polymerization photoinitiator.

19. (canceled)

20. The composition of claim 19, wherein said polymerization photoinitiator is selected from the group consisting of 2,2-dimethoxy-1,2-diphenylethan-1-one, bis(2,4,6-trimethylbenzoyl)-phenylphosphineoxide, 1-hydroxycyclohexyl benzophenone, trimethyl-benzoyl-diphenyl-phosphine-oxide, and combinations thereof.

21. The composition of claim 15, further comprising a filler.

22. The composition of claim 21, wherein said filler comprises at least one selected from the group consisting of a silica particle, Kevlar veil, PET mesh, fiber mesh, metal mesh, Multi-Walled Carbon NanoTube (MWCNTs), Carbon NanoTube (CNTs), organoclay, clay, alumina, titania, zirconia, carbon, bioglass, hydroxyapatite (HA) particle/mesh, quartz, barium glass, barium salt, titanium dioxide, and combinations thereof.
